(19) United States
(12) Patent Application Publication
(10) Pub. No.: US 2025/0280387 A1
(43) Pub. Date: Sep. 4, 2025

(54) ERROR MESSAGING FOR SIDELINK POSITIONING

(71) Applicant: Lenovo (Singapore) Pte. Limited, Singapore (SG)

(72) Inventors: Hyung-Nam Choi, Ottobrunn (DE); Robin Rajan Thomas, Bad Nauheim (DE)

(73) Assignee: Lenovo (Singapore) Pte. Limited, Singapore (SG)

(21) Appl. No.: 19/067,542

(22) Filed: Feb. 28, 2025

Related U.S. Application Data
(60) Provisional application No. 63/560,438, filed on Mar. 1, 2024.

(51) Int. Cl. H04W 64/00; G01S 5/02; H04L 43/0823

(52) U.S. Cl. CPC H04W 64/003; G01S 5/0236; H04L 43/0823

(57) ABSTRACT

Various aspects of the present disclosure relate to error messaging for sidelink positioning. A first device, such as a UE or a location management function (LMF), receives, from a second device, a first sidelink positioning protocol (SLPP) message comprising information associated with sidelink positioning. The first device determines sidelink positioning error information based on an error in the information associated with the sidelink positioning. The first device transmits a second SLPP message comprising at least one parameter that indicates the sidelink positioning error information. The second device transmits, to the first device, a third SLPP message based on the sidelink positioning error information.

### RELATED APPLICATION

This application claims priority to U.S. Provisional Application Ser. No. 63/560,438 filed Mar. 1, 2024, entitled “ERROR MESSAGING FOR SIDELINK POSITIONING,” the disclosure of which is incorporated by reference herein in its entirety.

### TECHNICAL FIELD

The present disclosure relates to wireless communications, and more specifically to communication of error messages.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A first device for wireless communications is described. The first device may be configured to, capable of, or operable to perform one or more operations as described herein. For example, the first device may be configured to, capable of, or operable to receive, from a second device, a first sidelink positioning protocol (SLPP) message including information associated with sidelink positioning, determine sidelink positioning error information based on an error in the information associated with the sidelink positioning, and transmit a second SLPP message including at least one parameter that indicates the sidelink positioning error information.

A processor (e.g., a standalone processor chipset, or a component of a first device) for wireless communications is described. The processor may be configured to, capable of, or operable to perform one or more operations as described herein. For example, the processor may be configured to, capable of, or operable to receive, from a device, a first SLPP message including information associated with sidelink positioning, determine sidelink positioning error information based on an error in the information associated with the sidelink positioning, and transmit a second SLPP message including at least one parameter that indicates the sidelink positioning error information.

A method performed or performable by a first device for wireless communications is described. The method may include receiving, from a second device, a first SLPP message including information associated with sidelink positioning, determining sidelink positioning error information based on an error in the information associated with the sidelink positioning, and transmitting a second SLPP message including at least one parameter that indicates the sidelink positioning error information.

In some implementations of the first device, the processor, and the method described herein, the at least one parameter includes one or more values indicating that the error in the information associated with the sidelink positioning corresponds to one or more of measurement information, location information, or assistance data information. In some implementations of the UE, the processor, and the method described herein, the one or more values are grouped according to a type of the sidelink positioning error information, where the type of the sidelink positioning error information includes at least one of a measurement information type, a location information type, or an assistance data information type. In some implementations of the UE, the processor, and the method described herein, the one or more values are grouped according to the type of the second device, where the type of the second device includes at least one of a target UE, an anchor UE, a server UE, or a location management function (LMF). In some implementations of the UE, the processor, and the method described herein, the one or more values are grouped according to a type of the second device, where the type of the second device includes at least one of a target UE, an anchor UE, a server UE, or an LMF. In some implementations of the UE, the processor, and the method described herein, the second SLPP message includes one or more of a first parameter that indicates at least one error associated with the first SLPP message, a second parameter that indicates at least one measurement information error associated with the information, a third parameter that indicates at least one location information error associated with the information, and a fourth parameter that indicates at least one assistance data information error associated with the information, where the at least one parameter includes at least one of the second parameter, the third parameter, or the fourth parameter. In some implementations of the UE, the processor, and the method described herein, the at least one parameter includes one or more respective parameters that indicate the at least one measurement information error, the at least one location information error, and the at least one assistance data information error are associated with at least one of a target UE, an anchor UE, a server UE, or an LMF.

In some implementations of the UE, the processor, and the method described herein, the second SLPP message includes one or more of a first parameter that indicates at least one error associated with the first SLPP message, a second parameter that indicates at least one error associated with the information associated with a target UE, a third parameter that indicates at least one error associated with the information associated with an anchor UE, and a fourth parameter that indicates at least one error associated with the information associated with a server UE or an LMF, where the at least one parameter includes at least one of the second parameter, the third parameter, or the fourth parameter. In some implementations of the UE, the processor, and the method described herein, the UE, the processor, and the method may further be configured to, capable of, or operable to receive, in response to the second SLPP message, a third SLPP message that indicates a third device associated with the sidelink positioning, where the first SLPP message indicates a fourth device associated with the sidelink positioning. In some implementations of the UE, the processor, and the method described herein, the UE, the processor, and the method may further be configured to, capable of, or operable to receive, in response to the second SLPP message, a third SLPP message that indicates additional information associated with the sidelink positioning, where the additional information includes one or more of measurements associated with the sidelink position. In some implementations of the UE, the processor, and the method described herein, the UE, the processor, and the method may further be configured to, capable of, or operable to receive, in response to the second SLPP message, a third SLPP message that indicates one or more first measurements associated with the sidelink positioning, where the information includes one or more second measurements.

In some implementations of the UE, the processor, and the method described herein, the first device includes at least one of a target UE, an anchor UE, a server UE, or an LMF. In some implementations of the UE, the processor, and the method described herein, the second device includes at least one of a target UE, an anchor UE, a server UE, or an LMF. In some implementations of the UE, the processor, and the method described herein, the information associated with the sidelink positioning includes one or more of measurements associated with the sidelink positioning, location information associated with the sidelink positioning, or assistance data information associated with the sidelink positioning. In some implementations of the UE, the processor, and the method described herein, the second SLPP message includes at least one of an SLPP error message, an SLPP provide assistance data message, or an SLPP provide location information message.

A first device for wireless communications is described. The first device may be configured to, capable of, or operable to perform one or more operations as described herein. For example, the first device may be configured to, capable of, or operable to receive, from a second device, a first SLPP message including at least one parameter that indicates sidelink positioning error information associated with a second SLPP message, where the sidelink positioning error information is based on an error in information associated with sidelink positioning, and transmit, to the second device, a third SLPP message based on the sidelink positioning error information.

A processor (e.g., a standalone processor chipset, or a component of a first device) for wireless communications is described. The processor may be configured to, capable of, or operable to perform one or more operations as described herein. For example, the processor may be configured to, capable of, or operable to receive, from a device, a first SLPP message including at least one parameter that indicates sidelink positioning error information associated with a second SLPP message, where the sidelink positioning error information is based on an error in information associated with sidelink positioning, and transmit, to the device, a third SLPP message based on the sidelink positioning error information.

A method performed or performable by a first device for wireless communications is described. The method may include receiving, from a second device, a first SLPP message including at least one parameter that indicates sidelink positioning error information associated with a second SLPP message, where the sidelink positioning error information is based on an error in information associated with sidelink positioning, and transmitting, to the second device, a third SLPP message based on the sidelink positioning error information.

In some implementations of the method and apparatuses described herein, the at least one parameter includes one or more values indicating that the error in the information associated with the sidelink positioning corresponds to one or more of measurement information, location information, or assistance data information. In some implementations of the first device, the processor, and the method described herein, the one or more values are grouped according to a type of the sidelink positioning error information, where the type of the sidelink positioning error information includes at least one of a measurement information type, a location information type, or an assistance data information type. In some implementations of the first device, the processor, and the method described herein, the one or more values are grouped according to the type of the second device, where the type of the second device includes at least one of a target UE, an anchor UE, or a server UE. In some implementations of the first device, the processor, and the method described herein, the one or more values are grouped according to a type of the second device, where the type of the second device includes at least one of a target UE, an anchor UE, a server UE, or an LMF. In some implementations of the first device, the processor, and the method described herein, the first SLPP message includes one or more of a first parameter that indicates at least one error associated with the second SLPP message, a second parameter that indicates at least one measurement information error associated with the information, a third parameter that indicates at least one location information error associated with the information, and a fourth parameter that indicates at least one assistance data information error associated with the information, where the at least one parameter includes at least one of the second parameter, the third parameter, or the fourth parameter. In some implementations of the first device, the processor, and the method described herein, the at least one parameter includes one or more respective parameters that indicate the at least one measurement information error, the at least one location information error, and the at least one assistance data information error are associated with at least one of a target UE, an anchor UE, a server UE, or an LMF.

In some implementations of the first device, the processor, and the method described herein, the first SLPP message includes one or more of a first parameter that indicates at least one error associated with the second SLPP message, a second parameter that indicates at least one error associated with the information associated with a target UE, a third parameter that indicates at least one error associated with the information associated with an anchor UE, and a fourth parameter that indicates at least one error associated with the information associated with a server UE or an LMF, where the at least one parameter includes at least one of the second parameter, the third parameter, or the fourth parameter. In some implementations of the first device, the processor, and the method described herein, the third SLPP message indicates a third device associated with the sidelink positioning, where the second SLPP message indicates a fourth device associated with the sidelink positioning. In some implementations of the first device, the processor, and the method described herein, the third SLPP message indicates additional information associated with the sidelink positioning, where the additional information includes one or more of measurements associated with the sidelink position. In some implementations of the first device, the processor, and the method described herein, the UE, the processor, and the method may further be configured to, capable of, or operable to transmit, prior to receiving the first SLPP message, the second SLPP message, where the second SLPP message includes one or more first measurements associated with the sidelink positioning, and obtains, based on receiving the first SLPP message, one or more second measurements associated with the sidelink positioning, where the third SLPP message includes the one or more second measurements.

In some implementations of the UE, the processor, and the method described herein, the first device includes at least one of a target UE, an anchor UE, a server UE, or an LMF. In some implementations of the UE, the processor, and the method described herein, the second device includes at least one of a target UE, an anchor UE, a server UE, or an LMF. In some implementations of the UE, the processor, and the method described herein, the information associated with the sidelink positioning includes one or more of measurements associated with the sidelink positioning, location information associated with the sidelink positioning, or assistance data information associated with the sidelink positioning. In some implementations of the UE, the processor, and the method described herein, the first SLPP message includes at least one of an SLPP error message, an SLPP provide assistance data message, or an SLPP provide location information message.

### BRIEF DESCRIPTION OF THE DRAWINGS

FIGS. 1 through 3 illustrate examples of wireless communications systems in accordance with aspects of the present disclosure.

FIG. 4 illustrates an example of a signaling diagram, in accordance with aspects of the present disclosure.

FIG. 5 illustrates an example of a wireless communications system, in accordance with aspects of the present disclosure.

FIGS. 6 through 8 illustrate examples of signaling diagrams, in accordance with aspects of the present disclosure.

FIG. 9 illustrates an example of a UE in accordance with aspects of the present disclosure.

FIG. 10 illustrates an example of a processor in accordance with aspects of the present disclosure.

FIG. 11 illustrates an example of an NE in accordance with aspects of the present disclosure.

FIG. 12 illustrates a flowchart of a method performed by a device (e.g., a UE or an NE) in accordance with aspects of the present disclosure.

FIG. 13 illustrates a flowchart of a method performed by a device (e.g., a UE or an NE) in accordance with aspects of the present disclosure.

### DETAILED DESCRIPTION

A wireless communications system can include multiple devices, such as one or more UEs and one or more NEs. In some variations, an NE can implement an LMF to manage location information of one or more devices served by the NE (e.g., one or more UEs). In some examples, a UE can communicate with another UE, which may be referred to as sidelink communication. For example, a UE can establish a wireless communications link with a neighboring UE (e.g., within a threshold distance from the UE) and can transmit or receive data, control signaling, or the like via the communications link. A device can obtain positioning information, such as angle of arrival (AoA) measurement, round-trip-time (RTT) measurements, time difference of arrival (TDOA) measurements, and time of arrival (TOA) measurements, among other information, from another device. One or more devices in communication via a sidelink communications link can include an anchor device, also referred to as an anchor UE, that transmits or receives reference signals (e.g., positioning reference signals (PRSs)) and provides positioning information for a target device, also referred to as a target UE. The target device can be in communication with a server device, such as an LMF and/or a server UE. A server UE is a UE that provides location server functionality in addition to, or as an alternative to, an LMF.

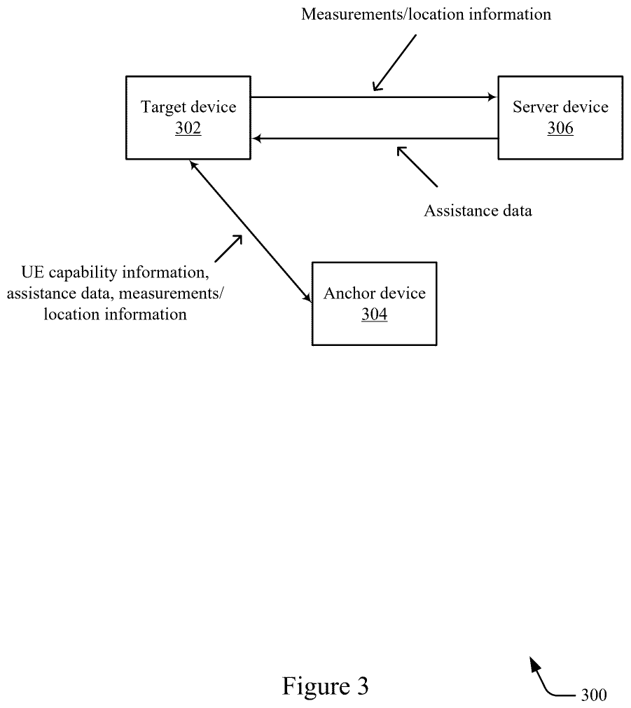

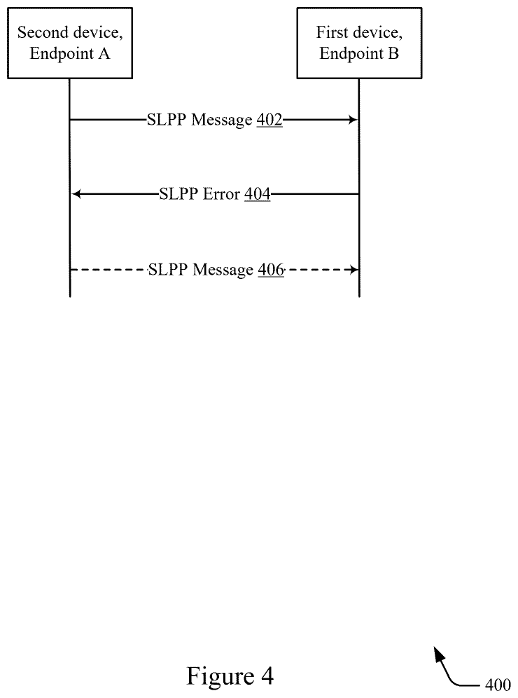

In some examples, a target device, a server device, an anchor device, and/or an LMF can transmit or receive one or more messages during a positioning operation, referred to as SLPP messages, which is described in further detail with respect to FIGS. 3 and 4. In some variations, the SLPP messages can include device capability information, measurement information, location information, and assistance data information, among other information. The information in the SLPP messages can include one or more errors, including, but not limited to, the SLPP message being received erroneously, with unexpected content, and/or with missing content. In some variations, a device (e.g., the target device, the server device, the anchor device, and/or the LMF) can detect the error in the SLPP message and can transmit an error message indicating the error in the SLPP message. However, the format of the error message may be insufficient to indicate the type of error that occurred, such that a device receiving the error message may be unable to determine what error occurred. The device receiving the error message may transmit additional signaling that incorrectly attempts to correct the error and/or that requests additional information from the device that detected the error, causing high signaling overhead and even failure of a sidelink positioning operation.

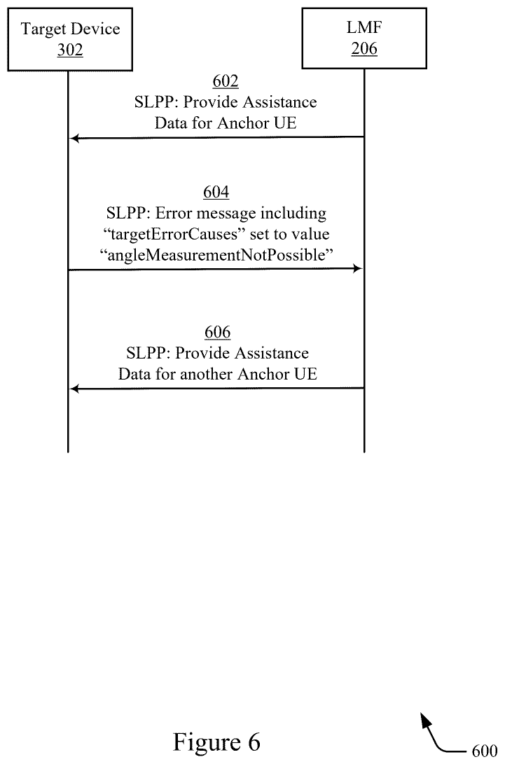

As described herein, to reduce signaling overhead related to incorrect attempts to correct an error in an SLPP message, messaging requesting and providing additional information related to the error, and/or failure of a sidelink positioning operation, a device can use a format for transmitting an indication of an error in an SLPP message that includes parameters that indicate the type of the error. For example, a first device (e.g., a target device, an anchor device, a server device, and/or an LMF) can receive a first SLPP message from a second device (e.g., a target device, an anchor device, a server device, and/or an LMF) that includes information for sidelink positioning. The information can include one or more of measurement information, location information, or assistance data information. The first device can detect one or more errors in the information, including, but not limited to, an error in the measurement information, an error in the location information, or an error in the assistance data information, which is described in further detail with respect to FIG. 4. The first device can transmit a second SLPP message with at least one parameter that indicates the detected error. For example, the first device can transmit the SLPP message to the second device or to another device. Different types of errors can be grouped according to an error cause (e.g., errors in measurement information, errors in location information, or errors in assistance data information), a type of device receiving the first SLPP message, or both. The second device can transmit a third SLPP message that corrects the error, which is described in further detail with respect to FIGS. 6 through 8.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

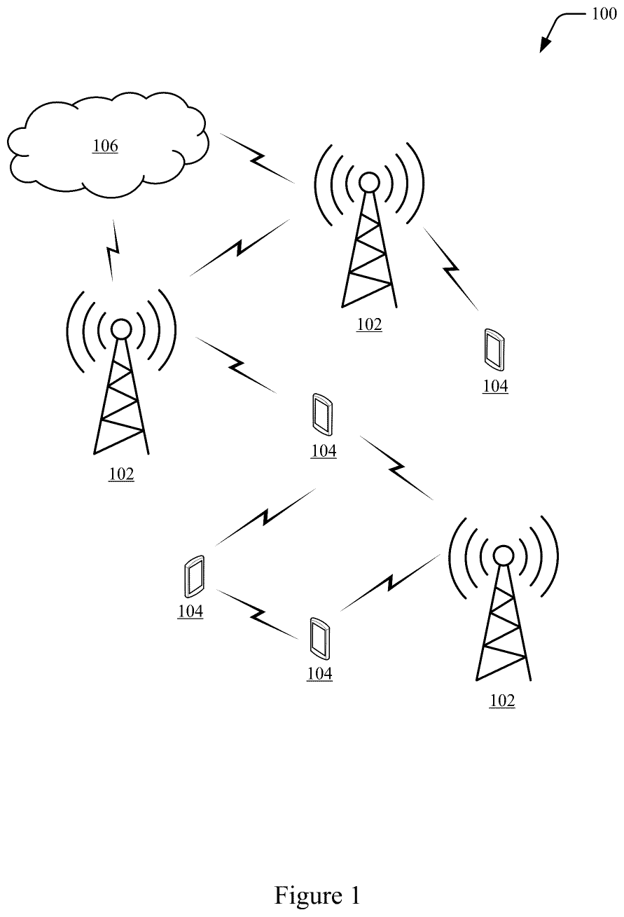

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be an NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communications link, which may be a wireless or wired connection. For example, an NE 102 and a UE 104 may perform wireless communications (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communications of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communications directly with other UEs 104 over a communications link. For example, a UE 104 may support wireless communications directly with another UE 104 over a device-to-device (D2D) communications link. In some implementations, such as vehicle-to-vehicle (V2V) deployments, vehicle-to-everything (V2X) deployments, or cellular-V2X deployments, the communications link may be referred to as a sidelink. For example, a UE 104 may support wireless communications directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHZ-24.25 GHZ), FR4 (52.6 GHz-114.25 GHZ), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 KHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 KHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, one or more UEs 104 can perform sidelink communications with each other via a sidelink communications link. A target UE 104, a server UE 104, an anchor UE 104, and/or an LMF (e.g., an NE 102) can transmit or receive one or more messages during a positioning operation, referred to as SLPP messages, which is described in further detail with respect to FIGS. 3 and 4. In some variations, the SLPP messages can include UE capability information, measurement information, location information, and assistance data information, among other information. The SLPP messages can include one or more errors, including, but not limited to, the SLPP message being received erroneously, with unexpected content, and/or with missing content. In some variations, a device (e.g., the target UE 104, the server UE 104, the anchor UE 104, and/or the LMF) can detect the error in the SLPP message and can transmit an error message indicating the error in the SLPP message. However, the format of the error message may be insufficient to indicate the type of error that occurred, such that a device receiving the error message may be unable to determine what error occurred. The device receiving the error message may transmit additional signaling that incorrectly attempts to correct the error and/or that requests additional information from the device that detected the error, causing high signaling overhead and even failure of a sidelink positioning operation.

In some examples, to reduce signaling overhead related to incorrect attempts to correct an error in an SLPP message, messaging requesting and providing additional information related to the error, and/or failure of a sidelink positioning operation, a device can use a format for transmitting an indication of an error in an SLPP message that includes parameters that indicate the type of the error. For example, a first device (e.g., a target UE 104, an anchor UE 104, a server UE 104, and/or an LMF) can receive a first SLPP message from a second device (e.g., a target UE 104, an anchor UE 104, a server UE 104, and/or an LMF) that includes information for sidelink positioning. The information can include one or more of measurement information, location information, or assistance data information. The first device can detect one or more errors in the information, such as an error in the measurement information, an error in the location information, or an error in the assistance data information, which is described in further detail with respect to FIG. 4. The first device can transmit a second SLPP message with at least one parameter that indicates the detected error. For example, the first device can transmit the SLPP message to the second device or to another device. Different types of errors can be grouped according to an error cause (e.g., errors in measurement information, errors in location information, or errors in assistance data information), a type of device receiving the first SLPP message, or both. The second device can transmit a third SLPP message that corrects the error, which is described in further detail with respect to FIGS. 6 through 8.

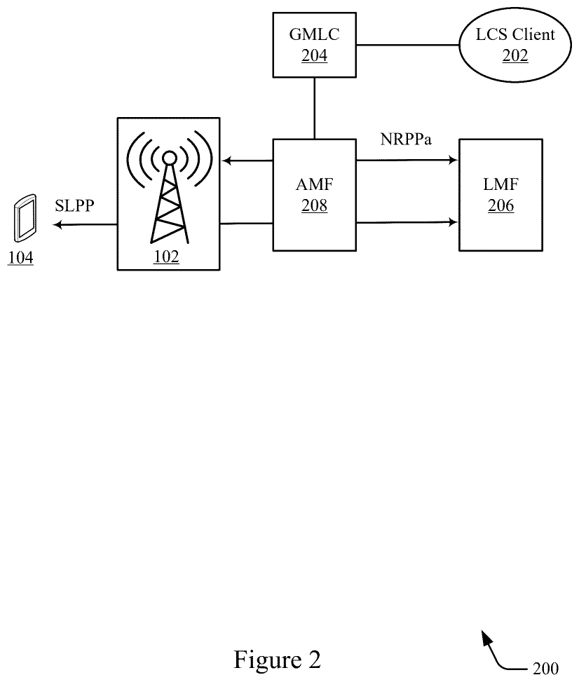

FIG. 2 illustrates an example of a wireless communications system 200 in accordance with aspects of the present disclosure. In some examples, the wireless communications system 200 implements aspects of the wireless communications system 100. For example, the wireless communications system 200 includes a UE 104 and an NE 102, which may be examples of a UE 104 and an NE 102 as described with reference to FIG. 1. In some examples, the wireless communications system 200 illustrates an example of a location service (LCS) architecture for sidelink positioning.

A LCS provides mechanisms to support mobile location techniques for operators, subscribers, and third-party service providers. Examples of location-based services include emergency services, tracking services, location-based information services (navigation, city sightseeing, location dependent content broadcast, mobile yellow pages, etc.). The location information may be requested by and reported to a client (e.g., application) associated with a UE 104, or by a client within or attached to a 5GC. In some examples, the wireless communications system 200 illustrates an exemplary LCS architecture for sidelink positioning, where an external LCS client 202 requests a current location of a target UE 104 from a 5GC. The external LCS client 202 interacts with a gateway mobile location center (GMLC) 204 for the purpose of obtaining location information for one or more UEs 104, referred to as target UEs 104. The LCS client 202 may reside in a UE 104 and may be implemented as hardware or software (e.g., an application). Example LCS clients 202 include, but are not limited to, a 911 emergency dispatch center (e.g., a public safety answering point (PSAP)), a mapping service, among others.

In some variations, a GMLC 204 is a first node that an external LCS client 202 accesses for location information in a public land mobile network (PLMN). The GMLC 204 works as a location server to an external application. An LMF 206 manages the overall coordination and scheduling of resources for a location of a UE 104 that is registered with or accesses a 5GC. The LMF 206 calculates or verifies a final location and a velocity estimate for the UE 104. Additionally, or alternatively, the LMF 206 estimates an achieved accuracy. The LMF 206 processes the location services request, which may include transferring assistance data to a target UE 104 to assist with UE-based and/or UE-assisted positioning and/or may include positioning of the target UE 104. The LMF 206 then indicates the position estimate for a UE 104 to an AMF 208. In the case of a location service requested by an entity other than the AMF 208 (e.g., a GMLC 204 or a UE 104), the AMF 208 indicates the location result to the entity. In a control-plane (C-plane) the LMF works as location server, where the C-plane is a portion of a network architecture responsible for managing and controlling the establishment, maintenance, and termination of communication sessions between devices.

In some cases, the AMF 208 includes functionality responsible for managing positioning for a target UE 104 for one or more different types of location requests. The AMF 208 receives a request for one or more location services associated with a defined target UE 104 from another entity (e.g., a GMLC 204 or another UE 104). The AMF 208 then sends a location services request to an LMF 206. A next generation-RAN (NG-RAN) node (e.g., an NE 102, a gNB, a base station, or the like in NR) is involved in the handling of various positioning procedures including positioning of a target UE 104, provision of location related information not associated with a target UE 104, and transfer of positioning messages between an AMF 208 or LMF 206 and a target UE 104.

The target UE 104 is a UE 104 for which a network or another UE 104 is to obtain a position (e.g., absolute, or relative). In some examples, an NR positioning protocol A (NRPPa) is a C-plane radio network layer signaling protocol between an NG-RAN node (e.g., the NE 102) and the LMF 206. An SLPP is a point-to-point positioning protocol that supports positioning and location related services for a target device, such as the target UE 104. In C-plane, SLPP is terminated between a target device and an LMF 206.

In some examples, there may be one or more different types of location requests for sidelink positioning and/or sidelink ranging. The types of requests can include, but are not limited to, a sidelink mobile terminated location request (SL-MT-LR) and a sidelink mobile originated location request (SL-MO-LR). For an SL-MT-LR, an LCS client 202 external to or internal to a serving PLMN sends a location request to the PLMN for the location of a target UE 104. For an SL-MO-LR, a UE 104 sends a request to a serving PLMN for location related information for the UE 104.

In some examples, the external LCS client 202, the GMLC 204, the AMF 208, the LMF 206, the NE 102, and the UE 104 can exchange signaling via one or more communications links. The communications links can include wired and/or wireless communications links. Example wired communications links include, but are not limited to, backhaul links. Example wireless communications links include, but are not limited to, over-the-air communications links. Exchanging signaling can include transmitting and/or receiving signaling, which may also be referred to as messages.

FIG. 3 illustrates an example of a wireless communications system 300 in accordance with aspects of the present disclosure. In some examples, the wireless communications system 300 implements aspects of the wireless communications system 100 and the wireless communications system 200. The wireless communications system 300 includes a target device 302, an anchor device 304, and a server device 306. The target device 302, the anchor device 304, and the server device 306 can be examples of UEs 104 as described with reference to FIGS. 1 and 2. Although the wireless communications system 300 illustrates an example of a server device 306 the wireless communications system 300 may additionally, or alternatively include an LMF (e.g., an LMF 206 as described with reference to FIG. 2). For example, one or more features described as being performed by the server device 306 may additionally, or alternatively, be performed by an LMF.

In some examples, one or more UEs can communicate with each other, which is referred to as sidelink communication. The UEs can perform sidelink positioning, which includes determining a geographical location of a UE or device in a wireless network (e.g., the wireless communications system 300) through direct communication between neighboring devices. For example, the UEs can transmit and receive reference signals, such as PRSs, over communications links between the UEs, referred to as a PC5 interface or PC5 communications links. The positioning of a UE, such as absolute position, relative position, or ranging information, can be determined from the reference signals. In some cases, an initiator device initiates a sidelink positioning and/or ranging session, where the initiator device may be an NE (e.g., gNB, LMF) a UE, or a roadside unit (RSU). In some variations, a responder device responds to a sidelink positioning and/or ranging session from an initiator device, where the responder device may be an NE (e.g., gNB, LMF), UE, or an RSU.

A target device 302, which may be a UE or other device for wireless communications, may be a device for which a location is being determined. That is, the target device 302 may be a device of interest for which the network or the device is to obtain a position (e.g., absolute, or relative). An anchor device 304, which may be a UE or other device for wireless communications, is a device supporting positioning of the target device 302. For example, the anchor device 304 transmits and/or receives reference signals for positioning, provides positioning-related information, etc., over the PC5 interface. The anchor device 304 may additionally, or alternatively, be referred to as a sidelink reference device or a sidelink reference UE. A server device 306, which may be a UE or other device for wireless communications, is a device that offers location calculation for sidelink positioning and ranging based services. The server device 306 interacts with other UEs over a PC5 interface to calculate the location of a target device 302. The target device 302 or sidelink reference device can act as a server device 306 if the target device 302 supports location calculation. The server device 306 may additionally, or alternatively, be referred to as a sidelink positioning server device or a sidelink positioning server UE.

In some examples, the wireless communications system 300 can include an assistant device, which may be a UE or other device for wireless communications. An assistant device is a device that supports sidelink positioning and/or ranging between an anchor device 304 and a target device 302 over a PC5 interface when direct sidelink positioning and/or ranging between the anchor device 304 and the target device 302 is not supported. The measurements and results of the sidelink positioning and/or ranging between the assistant device and the anchor device 304 and that between the assistant device and the target device 302 are determined and used to derive the sidelink positioning and ranging results between the target device 302 and the anchor device 304. In some variations, ranging refers to a determination of a distance and/or the direction between a UE and another entity (e.g., an anchor device 304 and a target device 302). In some cases, the wireless communications system 300 can include a sidelink positioning client device, also referred to as a sidelink positioning client UE or a client device. The sidelink positioning client device is a third-party device (e.g., other than the anchor device 304 and the target device 302) that initiates sidelink positioning and ranging service requests for an application.

In some cases, there may be one or more different types of sidelink positioning methods, including, but not limited to, sidelink-AoA (SL-AoA), sidelink-RTT (SL-RTT), sidelink-TDOA (SL-TDOA), and sidelink-TOA (SL-TOA). The SL-AoA positioning method makes use of sidelink angle of arrival measurements (e.g., and optionally sidelink-PRS-reference signal received power (SL-PRS-RSRP) and/or sidelink-PRS-reference signal received path power (SL-PRS-RSRPP)) of one or more sidelink PRSs received at the target device 302 from one or more peer devices (e.g., anchor devices 304) or SL-AoA measurements (e.g., and optionally SL-PRS-RSRP and/or SL-PRS-RSRPP) performed at one or more peer devices (e.g., anchor device 304) of sidelink PRSs transmitted by a target device 302. The SL-AoA measurements performed by a device of sidelink PRSs transmitted by a peer device determines the azimuth and vertical angle (e.g., the direction) between the pair of devices relative to a reference direction (e.g., geographical north). Direction measurements between a target device 302 and multiple peer devices can be used to determine the location of the target device 302 relative to the locations of the peer devices (e.g., anchor devices 304).

The SL-RTT positioning method makes use of sidelink reception-transmission time difference measurements (e.g., and optionally SL-PRS-RSRP and/or SL-PRS-RSRPP) of sidelink PRSs received at the target device 302 from one or more peer devices (e.g., anchor devices 304) and the sidelink reception-transmission time difference measurements (e.g., and optionally SL-PRS-RSRP and/or SL-PRS-RSRPP) performed at the one or more peer devices (e.g., anchor devices 304) of sidelink PRSs transmitted by the target device 302. The sidelink reception-transmission time difference measurements performed by a pair of devices provides for determining the distance and/or range between the pair of devices. Distance and/or range measurements between a target device 302 and multiple peer devices can be used to determine the location of the target device 302 relative to the locations of the peer devices (e.g., anchor devices 304). The SL-RTT positioning method may also be used for ranging between devices.

The SL-TDOA positioning method makes use of sidelink-reference signal time difference (SL-RSTD) (e.g., and optionally SL-PRS-RSRP and/or SL-PRS-RSRPP) of sidelink PRSs received at the target device 302 from two or more peer devices (e.g., anchor devices 304). The target device 302 measures the SL-RSTD (e.g., and optionally SL-PRS-RSRP and/or SL-PRS-RSRPP) of the received sidelink PRSs transmitted by two or more peer devices. SL-RSTD measurements between a target device 302 and multiple peer devices can be used to determine the location of the target device 302 relative to the locations of the peer devices (e.g., anchor devices 304).

The SL-TOA positioning method makes use of SL-RTOA (e.g., and optionally SL-PRS-RSRP and/or SL-PRS-RSRPP) of SL PRS transmitted by a target device 302 and received by multiple per devices (e.g., anchor devices 304). The peer devices measure the SL-RTOA (and optionally SL-PRS-RSRP and/or SL-PRS-RSRPP) of the sidelink PRSs transmitted by the target device 302. SL-RTOA measurements performed at multiple peer devices can be used to determine the location of the target device 302 relative to the locations of the peer devices (e.g., anchor devices 304).

The sidelink positioning methods support the determination of the absolute and relative position of the target device 302. Furthermore, the above positioning methods may be supported in a sidelink target device-based positioning mode, a sidelink target device-assisted positioning mode, or a server-based positioning mode, where the server may be a server device 306 or an LMF, as illustrated in Table 1.

TABLE 1

| | Sidelink target device- | Sidelink target device-assisted, |
|---|---|---|
| Method | based | Server-based |
| SL-AoA | Yes | Yes |
| SL-RTT | Yes | Yes |
| SL- | Yes | Yes |
| TDOA | | |
| SL-TOA | Yes | Yes |

For a sidelink target device-based positioning mode, a target device 302 calculates a location of the target device 302 based on measurements. For sidelink target device-assisted and/or server-based, the target device 302 performs measurements to obtain measurement values and sends the measurement values to the server device 306, where the position calculation takes place. Table 1 includes different sidelink positioning methods for the sidelink target device-based positioning mode, the sidelink target device-assisted positioning mode, and the server-based positioning mode.

The anchor device 304 and the target device 302 can transmit and/or receive signaling including UE capability information, assistance data information, measurements, and location information, among other information. The capability information can include one or more capabilities (e.g., related to sidelink positioning) supported by the target device 302 and/or the anchor device 304. The assistance data, also referred to as assistance data information, can include, but is not limited to, positioning assistance data information, such as an RSTD (e.g., information used for timing-based positioning techniques, including TDOA or TOA positioning), AoA information, AoD information, or any other measurements provided to assist in angle-based positioning techniques. The measurements can include reference signal measurements, such as SL-RSRP measurements, SL-RSRPP measurements, or any other reference signal measurements. The location information can include a geographic position of a device, including an absolute position or a relative position, such as relative to another device. The server device 306 can provide assistance data to the target device 302, and the target device 302 can provide measurements and/or location information to the server device 306 (e.g., obtained from the signaling between the target device 302 and the anchor device 304). In some variations, the anchor device 304 may not be in communication (e.g., wireless communications) with the server device 306.

FIG. 4 illustrates an example of a signaling diagram 400 in accordance with aspects of the present disclosure. In some examples, the signaling diagram 400 may implement aspects of the wireless communications system 100, the wireless communications system 200, and the wireless communications system 300. The signaling diagram 400 may illustrate an example of one or more SLPP messages between a first device, also referred to as Endpoint B, and a second device, also referred to as Endpoint A. In some cases, the first device and the second device may be examples of a target device 302, an anchor device 304, a server device 306, and/or an LMF 206, as described with reference to FIGS. 1 through 3. Alternative examples of the following may be implemented, where some processes are performed in a different order than described or are not performed. In some cases, processes may include additional features not mentioned below, or further processes may be added.

In some examples, the first device and the second device can transmit and receive one or more SLPP messages. For example, different types of SLPP messaging may occur between a target device, a server device, and an anchor device during a sidelink positioning operation. The server device can include a server UE or an LMF. SLPP messaging may take place between a target device and a server device, where the SLPP messaging may take place with regards to measurements, location information, and assistance data. Additionally, or alternatively, the SLPP messaging may take place between a target device and an anchor device, where the SLPP messaging may take place with regards to capability information of the target device and/or the anchor device, measurements, location information, and assistance data.

In some cases, at 402, the second device can transmit an SLPP message to the first device. In some cases, one or more errors may occur for different types of SLPP messaging. The errors can include, but are not limited to, coding errors in the SLPP message and incorrect data values in the SLPP message, among other errors. If the first device detects an error in the SLPP message at 402, then, at 404, the first device can transmit an SLPP error message to inform the second device about the error. For example, the Endpoint A sends an SLPP message to Endpoint B (e.g., an SLPP ProvideAssistanceData message). If the Endpoint B receives the message erroneously, with unexpected data, or detects that one or more data values are missing, then the Endpoint B sends the error message including error information to the Endpoint A. Upon receiving the error message, at 406, the Endpoint A may resend the SLPP message to the Endpoint B taking into consideration the received error information.

The first device can include an indication of the type of the error in the SLPP error message at 404. However, conventionally, there are relatively few (e.g., below a threshold, three) values to include in the SLPP error message to indicate error information. The values are referred to as common error cause values and can include a slppMessageHeaderError value when the first device (e.g., Endpoint B) detects a coding error in the SLPP header, an incorrectData Value value when the first device receives an incorrect data value, and an undefined value for other cases. The other cases can include, but are not limited to, when the first device detects that the SLPP message is a duplicate of a previously received SLPP message, one or more data values are missing in the SLPP message, or the SLPP message includes unexpected data (e.g., configuration for a positioning method that is not supported by the first device). However, the conventional values for indicating the error in the SLPP error message may be insufficient to indicate the type of error that occurred, such that the first device may be unable to determine what error occurred. The first device may transmit additional signaling that incorrectly attempts to correct the error and/or that requests additional information from the second device, causing high signaling overhead and even failure of a sidelink positioning operation.

In some examples, one or more additional parameters can be defined for the SLPP error to indicate a type of the error. For example, the first device can include sidelink positioning-specific error information in an SLPP message to the second device. Additionally, or alternatively, the error information may be grouped according to an error type and/or a type of the first device. In some cases, the error information may be grouped according to an error type, as illustrated in Table 2.

TABLE 2

| Type | Error cause value | Description |
|---|---|---|
| Measurements | unableToMeasureReference Anchor | Used by the Target when the |
| | | Target is unable to measure |
| | | the reference Anchor. |
| | unableToMeasureAnyAnchor | Used by the Target when the |
| | | Target is unable to measure |
| | | any Anchor. |
| | unableToMeasureTarget | Used by the Anchor when |
| | | the Anchor is unable to |
| | | measure the Target. |
| | notAllRequestedMeasurementsPossible | Used by the Target or the |
| | | Anchor when not all |
| | | requested measurements are |
| | | possible. |
| | notEnoughAnchorReceived | Used by the Target when the |
| | | Target does not receive a |
| | | sidelink PRS from a required |
| | | number of Anchors. |
| | rsrpMeasurementNotPossible | Used by the Target or the |
| | | Anchor when SL-PRS-RSRP |
| | | measurements are not |
| | | possible. |
| | rsrppMeasurementNotPossible | Used by the Target or the |
| | | Anchor when SL-PRS- |
| | | RSRPP measurements are |
| | | not possible. |
| | angleMeasurementNotPossible | Used by the Target or the |
| | | Anchor when SL-AoA |
| | | measurements (azimuth, |
| | | vertical) are not possible. |
| | ueRxTxMeasurementNotPossible | Used by the Target or the |
| | | Anchor when sidelink |
| | | reception-transmission time |
| | | difference measurements are |
| | | not possible. |
| | rstdMeasurementNotPossible | Used by the Target when SL- |
| | | RSTD measurements are not |
| | | possible. |
| | rtoaMeasurementNotPossible | Used by the Anchor when |
| | | SL-TOA measurements are |
| | | not possible. |
| | notEnoughMeasurementsForUeBasedSL-AOA | Used by the Target when not |
| | | enough measurements are |
| | | available for the Target- |
| | | based SL-AoA. |
| | notEnoughMeasurementsForUeBasedSL-RTT | Used by the Target when not |
| | | enough measurements are |
| | | available for Target-based |
| | | SL-RTT. |
| | notEnoughMeasurementsForUeBasedSL-TDOA | Used by the Target when not |
| | | enough measurements are |
| | | available for Target-based |
| | | SL-TDOA. |
| | notEnoughMeasurementsForUeBasedSL-TOA | Used by the Target when not |
| | | enough measurements are |
| | | available for Target-based |
| | | SL-TOA. |
| Location | unableToEstimateRelativeLocation | Used by the Target or the |
| information | | Server when the Target or |
| | | the Server is unable to |
| | | estimate relative location. |
| | unableToEstimateAbsoluteLocation | Used by the Target or the |
| | | Server when the Target or |
| | | the Server is unable to |
| | | estimate absolute location. |
| | unableToEstimateDistance | Used by the Target or the |
| | | Server when the Target or |
| | | the Server is unable to |
| | | estimate distance/range. |
| | unableToEstimateAbsoluteVelocity | Used by the Target or the |
| | | Server when the Target or |
| | | the Server is unable to |
| | | estimate absolute velocity. |
| | unableToEstimateRelativeVelocity | Used by the Target or the |
| | | Server when the Target or |
| | | the Server is unable to |
| | | estimate relative velocity. |
| | unableToEstimateDirection | Used by the Target or the |
| | | Server when the Target or |
| | | the Server is unable to |
| | | estimate absolute/relative |
| | | direction in relation to a |
| | | reference direction. |
| Assistance | adMissing | Used by the Target or the |
| data | | Anchor when requested |
| | | assistance data is missing. |
| | adNotSupportedByServer | Used by the Server when |
| | | requested assistance data is |
| | | not supported. |
| | adSupportedButCurrentlyNotAvailableByServer | Used by the Server when |
| | | requested assistance data is |
| | | supported but currently not |
| | | available. |
| | notAllrequestedADAvailable | Used by the Server when not |
| | | all requested assistance data |
| | | is available. |
| | anchorLocationInfoNotAvailable | Used by the Anchor or the |
| | | Server when requested |
| | | location information of the |
| | | Anchor is not available. |
| | arpLocationInfoNotAvailable | Used by the Anchor or the |
| | | Server when requested |
| | | location information of the |
| | | antenna reference point |
| | | (ARP) is not available. |

In some other cases, the error information may be grouped according to a type of the first device, also referred to as a receiving device (e.g., a device receiving the SLPP message at 402), as illustrated in Table 3.

TABLE 3

| | | Target | Anchor | Server |
|---|---|---|---|---|
| | | error | error | error |
| Type | Error cause value | causes | causes | causes |
| Measurements | unableToMeasureReferenceAnchor | X | | |
| | unableToMeasureAnyAnchor | X | | |
| | unableToMeasureTarget | | X | |
| | notAllRequestedMeasurementsPossible | X | X | |
| | notEnoughAnchorReceived | X | | |
| | rsrpMeasurementNotPossible | X | X | |
| | rsrppMeasurementNotPossible | X | X | |
| | angleMeasurementNotPossible | X | X | |
| | ueRxTxMeasurementNotPossible | X | X | |
| | rstdMeasurementNotPossible | X | | |
| | rtoaMeasurementNotPossible | | X | |
| | notEnoughMeasurementsForUeBasedSL-AOA | X | | |
| | notEnoughMeasurementsForUeBasedSL-RTT | X | | |
| | notEnoughMeasurementsForUeBasedSL-TDOA | X | | |
| | notEnoughMeasurementsForUeBasedSL-TOA | X | | |
| Location | unableToEstimateRelativeLocation | X | | X |
| information | unableToEstimateAbsoluteLocation | | | X |
| | unableToEstimateDistance | X | | X |
| | unabletoEstimateDirection | X | | X |
| | unableToEstimateAbsoluteVelocity | X | | X |
| | unableToEstimateRelativeVelocity | X | | X |
| Assistance | adMissing | X | X | |
| data | adNotSupportedByServer | | | X |
| | adSupportedButCurrentlyNotAvailableByServer | | | X |
| | notAllrequestedADAvailable | | | X |
| | anchorLocationInfoNotAvailable | | X | X |
| | arpLocationInfoNotAvailable | | X | X |

In some other cases, the error information may be grouped according to a type of the error information, as well as the type of the first device. In Table 2 and Table 3, “Target” refers to a target device, “Anchor” refers to an anchor device, and “Server” refers to a server device (e.g., a server UE or an LMF). In some examples, the error information may be grouped according to a sidelink positioning method, such as according to SL-AoA, SL-RTT, SL-TDOA, and SL-TOA.

In some examples, the first device transmits the sidelink positioning-specific error information via the SLPP error message. The SLPP error message includes additional, new parameters that include the new error information. Tables 4 through 6 illustrate a format of the SLPP error message based on the option for grouping the error information. For example, Table 4 illustrates a format of the SLPP error message according to the type of error information.

TABLE 4

| Message | Value | Description |
|---|---|---|
| Error | | |
| >commonIEsError | ENUMERATED{undefined, | |
| | slppMessageHeaderError, | |
| | slppMessageBodyError, | |
| | incorrectDataValue} | |
| >measurementsError | See Table 2 | Contains the error cause |
| | | values that are defined for |
| | | measurements. |
| >locationInfoError | See Table 2 | Contains the error cause |
| | | values that are defined for |
| | | location information. |
| >assistanceDataError | See Table 2 | Contains the error cause |
| | | values that are defined for |
| | | assistance data. |

In some examples, Table 5 illustrates a format of the SLPP error message according to the type of the first device.

TABLE 5

| Message | Value | Description |
|---|---|---|
| Error | | |
| >commonIEsError | ENUMERATED{undefined, | |
| | slppMessageHeaderError, | |
| | slppMessageBodyError, | |
| | incorrectDataValue} | |
| >targetErrorCauses | See Table 3 | Contains the error cause |
| | | values that are defined |
| | | for Target. |
| >anchorErrorCauses | See Table 3 | Contains the error cause |
| | | values that are defined |
| | | for Anchor. |
| >serverErrorCauses | See Table 3 | Contains the error cause |
| | | values that are defined |
| | | for Server. |

In some examples. Table 6 illustrates a format of the SLPP error message according to the type of the error information and the type of the first device.

TABLE 6

| Message | Value | Description |
|---|---|---|
| Error | | |
| >commonIEsError | ENUMERATED{undefined, | |
| | slppMessageHeaderError, | |
| | slppMessageBodyError, | |
| | incorrectDataValue} | |
| >measurementsError | | |
| >>targetErrorCauses | See Table 3 | Contains the error cause |
| | | values that are defined for |
| | | measurements and Target. |
| >>anchorErrorCauses | See Table 3 | Contains the error cause |
| | | values that are defined for |
| | | measurements and Anchor. |
| >locationInfoError | | |
| >>targetErrorCauses | See Table 3 | Contains the error cause |
| | | values that are defined for |
| | | location information and |
| | | Target. |
| >>serverErrorCauses | See Table 3 | Contains the error cause |
| | | values that are defined for |
| | | location information and |
| | | Server. |
| >assistanceDataError | | |
| >>targetErrorCauses | See Table 3 | Contains the error cause |
| | | values that are defined for |
| | | assistance data and Target. |
| >>anchorErrorCauses | See Table 3 | Contains the error cause |
| | | values that are defined for |
| | | assistance data and Anchor. |
| >>serverErrorCauses | See Table 3 | Contains the error cause |
| | | values that are defined for |
| | | assistance data and Server. |

In some examples, the first device sends the sidelink positioning-specific error information to the second device via an SLPP message other than the SLPP error message. For example, the first device sends the sidelink positioning-specific error information via an SLPP ProvideAssistanceData message or an SLPP Provide LocationInformation message using one or more sidelink positioning-specific information elements (IEs). The sidelink positioning-specific IEs can include, but are not limited to, a CommonSL-PRS-MethodsIEsProvideAssistanceData IE, an CommonSL-PRS-MethodsIEsProvideLocationInformation IE, an SL-AOA-ProvideAssistanceData IE, an SL-AOA-ProvideLocationInformation IE, an SL-RTT-ProvideAssistance Data IE, an SL-RTT-Provide LocationInformation IE, an SL-TDOA-ProvideAssistanceData IE, an SL-TDOA-Provide LocationInformation IE, an SL-TOA-ProvideAssistanceData IE, and an SL-TOA-Provide LocationInformation.

The second device can determine the error that occurred with the SLPP message by using the additional information (e.g., the sidelink positioning-specific error information) sent by the first device, which reduces signaling overhead, as well as reduces sidelink positioning failure between the first device and the second device.

At 402, the first device receives the first SLPP message from the second device. The first SLPP message includes information associated with sidelink positioning. For example, the information includes, but is not limited to, measurements (e.g., PRS measurements) associated with the sidelink positioning, location information associated with the sidelink positioning, or assistance data information associated with the sidelink positioning.

After receiving the SLPP message at 402, the first device determines sidelink positioning error information by detecting an error in the information in the first SLPP message. For example, the first device can detect one of the errors in Tables 2 and 3.

At 404, the first device transmits a second SLPP message (e.g., an SLPP error message, an SLPP provide assistance data message, or an SLPP provide location information message) that includes at least one parameter indicating the sidelink positioning error information. The first device can transmit the second SLPP message to the second device and/or to another device. For example, the first device can receive the SLPP message at 402 from a UE and can transmit the second SLPP message to the same UE or another UE. In some other examples, the first device can receive the SLPP message at 402 from an LMF and can transmit the second SLPP message to the same LMF or to a UE.

In some examples, the at least one parameter includes one or more values indicating that the error in the information associated with the sidelink positioning corresponds to one or more of measurement information, location information, or assistance data information. In some variations, the one or more values are grouped according to a type of the sidelink positioning error information, where the type of the sidelink positioning error information includes at least one of a measurement information type, a location information type, or an assistance data information type. Additionally, or alternatively, the one or more values are grouped according to the type of the second device, where the type of the second device includes at least one of a target UE, an anchor UE, a server UE, or an LMF.

In some cases, the format of the second SLPP message can define one or more parameters for the first device to include in the second SLPP message. For example, the second SLPP message includes one or more of a first parameter that indicates at least one error associated with the first SLPP message, a second parameter that indicates at least one measurement information error associated with the information, a third parameter that indicates at least one location information error associated with the information, and a fourth parameter that indicates at least one assistance data information error associated with the information. The parameter that indicates the sidelink positioning error information includes at least one of the second parameter, the third parameter, or the fourth parameter. Additionally, or alternatively, the parameter that indicates the sidelink positioning error information includes one or more respective parameters that indicate the at least one measurement information error, the at least one location information error, and the at least one assistance data information error are associated with at least one of a target UE, an anchor UE, a server UE, or an LMF.

In some other examples, the second SLPP message includes one or more of a first parameter that indicates at least one error associated with the first SLPP message, a second parameter that indicates at least one error associated with the information associated with a target UE, a third parameter that indicates at least one error associated with the information associated with an anchor UE, and a fourth parameter that indicates at least one error associated with the information associated with a server UE or an LMF. The parameter that indicates the sidelink positioning error information includes at least one of the second parameter, the third parameter, or the fourth parameter.

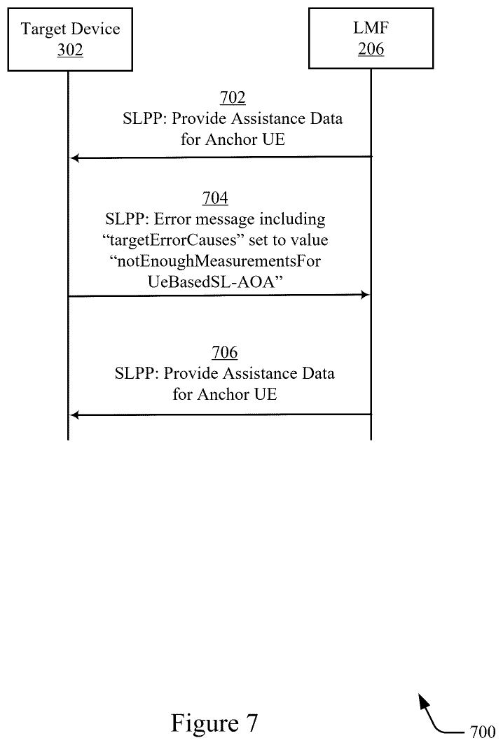

In some examples, at 406, the second device and/or another device transmits a third SLPP message to the first device based on the sidelink positioning error information. For example, the first device receives a third SLPP message that indicates a new anchor device (e.g., a third device) associated with the sidelink positioning, which is described in further detail with respect to FIG. 6. In some other examples, the first device receives a third SLPP message that indicates additional information associated with the sidelink positioning, which is described in further detail with respect to FIG. 7. In some other examples, the first device receives a third SLPP message that indicates one or more measurements associated with the sidelink positioning, where the information includes one or more other measurements. For example, the second device can perform additional measurements to obtain measurement values in response to receiving the second message indicating the error. In some examples, the first device and/or the second device includes a target UE, an anchor UE, a server UE, or an LMF.

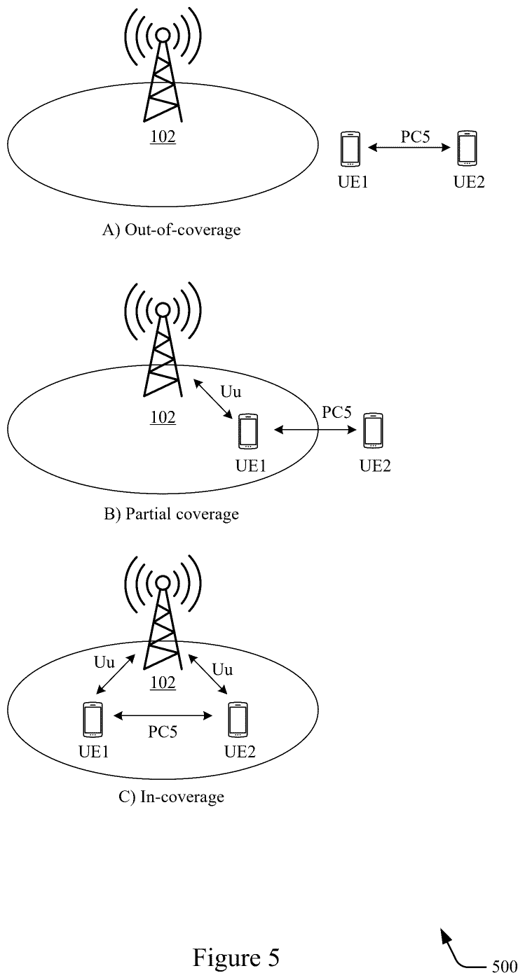

FIG. 5 illustrates an example of a wireless communications system 500 in accordance with aspects of the present disclosure. In some examples, the wireless communications system 500 implements aspects of the wireless communications system 100, the wireless communications system 200, the wireless communications system 300, and the signaling diagram 400. The wireless communications system 500 includes one or more UEs, such as the UE1 and the UE2, and an NE 102, which may be examples of UEs 104, and an NE 102 as described with reference to FIG. 1.

In some examples, UEs (e.g., the UE1 and the UE2) can communicate with each other, which is referred to as sidelink communication. For example, the UEs can transmit and receive control signaling and/or data over communications links between the UEs, referred to as a PC5 interface or PC5 communications links. Additionally, or alternatively, one or more UEs (e.g., the UE1 and/or the UE2) can communicate with an NE 102. For example, a UE and an NE 102 can transmit and receive control signaling and/or data over a communications link between the UE and the NE 102, referred to as a Uu interface or a Uu communications link.

The feature sidelink communication and discovery was introduced in Rel-16 NR to support V2X and non-V2X services. The interface used for sidelink communication (transmission/reception of user traffic) and discovery between two UEs in proximity is denoted as PC5. Table 2 and FIG. 4 show the scenarios which are supported for SL communication and discovery where UE1 and UE2 are located in-coverage (IC), partial coverage (PC) and out-of-coverage (OOC) of a cell.

In some examples, the transmission and reception of user traffic over the PC5 interface is supported for unicast, groupcast, and broadcast signaling. The transmission and reception of signaling traffic over the PC5 interface is supported for unicast. Sidelink communication over a PC5 interface is defined as a logical connection between two UEs and is identified by a pair of source and destination Layer-2 identifiers (IDs). Source and destination Layer-2 IDs identify the source and the target of the sidelink communication, respectively. For a cast type, a corresponding pair of a source Layer-2 ID, and a destination Layer-2 ID may be used. The Layer-2 IDs are transmitted in a medium access control (MAC) subheader associated with a sidelink-shared channel (SL-SCH) transport channel.

To enable sidelink communication between UEs in proximity, one or more UEs can perform a sidelink discovery procedure. For proximity-based services (ProSe), a separate sidelink discovery procedure is used by one or more UEs to discover or to be discovered by other UEs in proximity (e.g., within a threshold distance). For example, a UE that wants to discover other UEs in proximity transmits a discovery message over a PC5 interface. Other UEs in proximity monitor the discovery message, and if a UE of the other UEs wants to be discovered the UE may respond with a discovery response message. After discovery, the UE can establish a sidelink communication connection with respective UEs that responded. Sidelink discovery messages and sidelink communication user traffic are sent on the same physical sidelink shared channel (PSSCH) but using different sidelink resources. The range for sidelink communication and discovery may vary (e.g., from 50 meters (m) up to 1000 m) based on the use case and type of device (e.g., vehicle, sensor).

The wireless communications system 500 illustrates three different sidelink communication and discovery scenarios. In scenario A, both the UE1 and the UE2 are outside of a coverage area (e.g., a geographic range to which the NE 102 can serve UEs) of the NE 102. In scenario B, the UE1 is within a coverage area of the NE 102 and the UE 2 is outside of the coverage area of the NE 102. In scenario C, the UE1 and the UE2 are within the coverage area of the NE 102. The different scenarios are also illustrated in Table 7.

TABLE 7

| # | Coverage scenario | UE1 | UE2 |
|---|---|---|---|
| A | Out-of-coverage | Out-of-coverage | Out-of-coverage |
| B | Partial coverage | In-coverage | Out-of-coverage |
| C | In-coverage | In-coverage | In-coverage |

FIG. 6 illustrates an example of a signaling diagram 600 in accordance with aspects of the present disclosure. In some examples, the signaling diagram 600 may implement aspects of the wireless communications system 100, the wireless communications system 200, the wireless communications system 300, the signaling diagram 400, and the wireless communications system 500. The signaling diagram 600 may illustrate an example of one or more SLPP messages between a target device 302 and an LMF 206, which may be examples of a target device 302 and an LMF 206, as described with reference to FIGS. 1 through 5. Alternative examples of the following may be implemented, where some processes are performed in a different order than described or are not performed. In some cases, processes may include additional features not mentioned below, or further processes may be added.

In some examples, the signaling diagram 600 illustrates an example of a network-based sidelink positioning operation for an SL-MT-LR, where an LMF 206, a target device 302 (e.g., a target UE) and an anchor device are involved. The target device 302 and the anchor device may be in network coverage. In some examples, the signaling diagram 600 may implement a sidelink target device-assisted, server-based positioning mode, where the absolute location of the target device 302 is determined using an SL-AoA positioning method. In some variations, the Endpoint A is the LMF 206, and Endpoint B is the target device 302, as described with reference to FIG. 4. In some examples, the sidelink positioning-specific error information is grouped according to Table 3 (e.g., sidelink positioning-specific error information are grouped according to the type of the first device). In some variations, the sidelink positioning-specific error information is sent via the SLPP error message using the message format according to Table 5.

At 602, the target device 302 receives an SLPP ProvideAssistanceData message from the LMF that includes assistance data (e.g., assistance data information) to enable the target device 302 to obtain SL-AoA measurements of sidelink PRSs sent from an anchor device. The target device 302 receives the SLPP message but fails to measure sidelink PRSs sent from the anchor device. As result, at 604, the target device 302 sends the SLPP error message to the LMF 206 including the parameter “targetErrorCauses” set to the value “angleMeasurementNotPossible,” according to Table 8.

TABLE 8

| Message | Value |
|---|---|
| Error | |
| >commonIEsError | Not present |
| >targetErrorCauses | “angleMeasurementNotPossible” |
| >anchorErrorCauses | Not present |
| >serverErrorCauses | Not present |

Upon receiving the error message, at 606, the LMF 206 sends the SLPP ProvideAssistanceData message to the target device 302, but this time the SLPP ProvideAssistanceData message includes assistance data for another anchor device.

FIG. 7 illustrates an example of a signaling diagram 700 in accordance with aspects of the present disclosure. In some examples, the signaling diagram 700 may implement aspects of the wireless communications system 100, the wireless communications system 200, the wireless communications system 300, the signaling diagram 400, the wireless communications system 500, and the signaling diagram 600. The signaling diagram 700 may illustrate an example of one or more SLPP messages between a target device 302 and an LMF 206, which may be examples of a target device 302 and an LMF 206, as described with reference to FIGS. 1 through 6. Alternative examples of the following may be implemented, where some processes are performed in a different order than described or are not performed. In some cases, processes may include additional features not mentioned below, or further processes may be added.

In some examples, the signaling diagram 700 illustrates an example of a network-based sidelink positioning operation for an SL-MT-LR, where an LMF 206, a target device 302 (e.g., a target UE) and an anchor device are involved. The target device 302 and the anchor device may be in network coverage. In some examples, the signaling diagram 700 may implement a sidelink target device-based positioning mode, where the absolute location of the target device 302 is determined using an SL-AoA positioning method. In some variations, the target device 302 is configured by the LMF 206 to send the determined location to the LMF 206. The Endpoint A is the LMF 206, and Endpoint B is the target device 302, as described with reference to FIG. 4. In some examples, the sidelink positioning-specific error information is grouped according to Table 3 (e.g., sidelink positioning-specific error information are grouped according to the type of the first device). In some variations, the sidelink positioning-specific error information is sent via the SLPP error message using the message format according to Table 5.

At 702, the target device 302 receives an SLPP Provide AssistanceData message from the LMF 206 including assistance data to enable the target device 302 to determine a location of the target device 302 based on SL-AoA measurements of one or more sidelink PRSs sent from an anchor device. The target device 302 receives the SLPP message and obtains SL-AoA measurements of sidelink PRSs sent from the anchor device. However, the target device 302 fails to determine the location of the target device 302 based on the obtained measurements. As result, at 704, the target device 302 sends the error message to the LMF 206. The error message includes the parameter “targetErrorCauses” set to the value “notEnoughMeasurementsForUeBasedSL-AOA,” as illustrated in Table 9.

TABLE 9

| Message | Value |
|---|---|
| Error | |
| >commonIEsError | Not present |
| >targetErrorCauses | “notEnoughMeasurementsForUeBasedSL-AOA” |
| >anchorErrorCauses | Not present |
| >serverErrorCauses | Not present |

Upon receiving the error message, at 706, the LMF 206 sends the SLPP ProvideAssistanceData message to the target device 302, but this time the SLPP ProvideAssistanceData message includes updated assistance data for the anchor device.

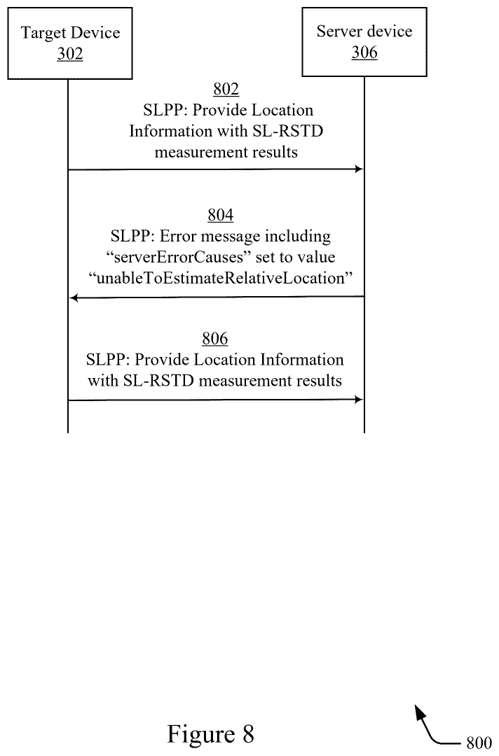

FIG. 8 illustrates an example of a signaling diagram 800 in accordance with aspects of the present disclosure. In some examples, the signaling diagram 800 may implement aspects of the wireless communications system 100, the wireless communications system 200, the wireless communications system 300, the signaling diagram 400, the wireless communications system 500, the signaling diagram 600, and the signaling diagram 700. The signaling diagram 800 may illustrate an example of one or more SLPP messages between a target device 302 and a server device 306, which may be examples of a target device 302 and a server device 306, as described with reference to FIGS. 1 through 7. Alternative examples of the following may be implemented, where some processes are performed in a different order than described or are not performed. In some cases, processes may include additional features not mentioned below, or further processes may be added.

In some examples, the signaling diagram 800 illustrates an example of a UE-based sidelink positioning operation for SL-MO-LR, where the server device 306, the target device 302, and multiple anchor devices (e.g., three anchor devices) are involved. The server device 306, the target device 302, and the anchor devices are out-of-coverage. In some examples, the signaling diagram 800 may implement a sidelink-target UE-assisted, server-based positioning mode, where the relative location of the target device 302 is determined based on an SL-TDOA positioning method. The target device 302 receives assistance data from the server device 306 to enable the target device 302 to obtain SL-RSTD measurements of one or more sidelink PRSs sent from the anchor devices. The Endpoint A is the target device 302, and Endpoint B is the server device 306, as described with reference to FIG. 4. In some examples, the sidelink positioning-specific error information is grouped according to Table 3 (e.g., sidelink positioning-specific error information are grouped according to the type of the first device). In some variations, the sidelink positioning-specific error information is sent via the SLPP error message using the message format according to Table 5.

At 802, the target device 302 obtains SL-RSTD measurements of one or more sidelink PRSs sent from the anchor devices and sends the SL-RSTD measurements to the server device 306. For example, the target device 302 sends the SL-RSTD measurements to the server device 306 in an SLPP ProvideLocationInformation message that includes the measurement results. The server device 306 receives the SLPP message but fails to determine the location of the target device 302 based on the received measurements. As result, at 804, the server device 306 sends an error message to the target device 302 including the parameter “serverErrorCauses” set to the value “unableToEstimateRelativeLocation,” as illustrated in Table 10.

TABLE 10

| Message | Value |
|---|---|
| Error | |
| >commonIEsError | Not present |
| >targetErrorCauses | Not present |
| >anchorErrorCauses | Not present |
| >serverErrorCauses | “unableToEstimateRelativeLocation” |

Upon receiving the error message, at 806, the target device 302 repeats the SL-RSTD measurements of sidelink PRSs sent from the anchor devices and sends the obtained SL-RSTD measurements to the server device 306 in an SLPP ProvideLocationInformation message.

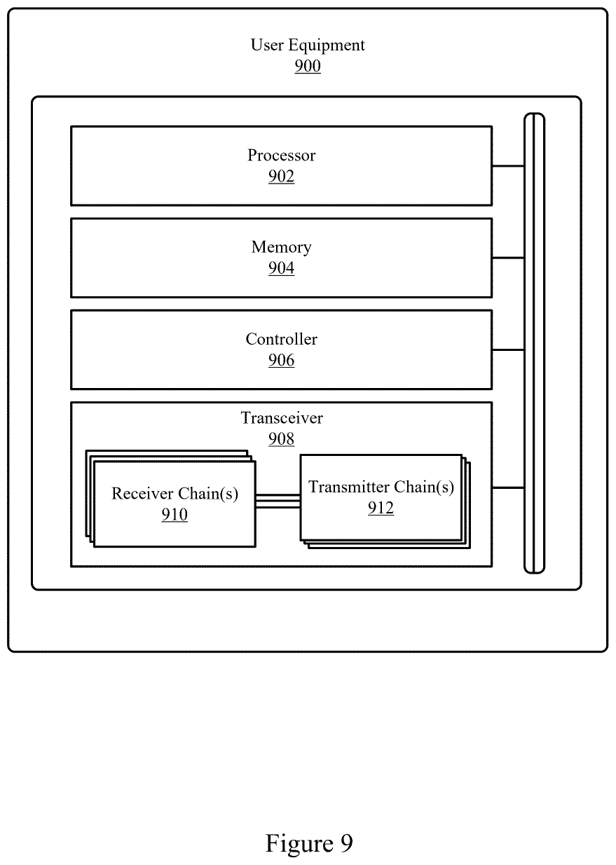

FIG. 9 illustrates an example of a UE 900 in accordance with aspects of the present disclosure. The UE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the UE 900 to perform various functions of the present disclosure.

The memory 904 may include volatile or non-volatile memory. The memory 904 may store computer-readable, computer-executable code including instructions when executed by the processor 902 cause the UE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured (e.g., operable) to cause the UE 900 to perform one or more of the functions described herein (e.g., executing, by the processor 902, instructions stored in the memory 904). For example, the processor 902 may support wireless communications at the UE 900 in accordance with examples as disclosed herein. The UE 900 may be configured to or operable to support a means for receiving, from a second device, a first SLPP message including information associated with sidelink positioning, determining sidelink positioning error information based on an error in the information associated with the sidelink positioning, and transmitting a second SLPP message including at least one parameter that indicates the sidelink positioning error information.

Additionally, the UE 900 may be configured to support any one or combination of the at least one parameter includes one or more values indicating that the error in the information associated with the sidelink positioning corresponds to one or more of measurement information, location information, or assistance data information. Additionally, or alternatively, the one or more values are grouped according to a type of the sidelink positioning error information, where the type of the sidelink positioning error information includes at least one of a measurement information type, a location information type, or an assistance data information type. Additionally, or alternatively, the one or more values are grouped according to the type of the second device, where the type of the second device includes at least one of a target UE, an anchor UE, a server UE, or an LMF. Additionally, or alternatively, the one or more values are grouped according to a type of the second device, where the type of the second device includes at least one of a target UE, an anchor UE, a server UE, or an LMF. Additionally, or alternatively, the second SLPP message includes one or more of a first parameter that indicates at least one error associated with the first SLPP message, a second parameter that indicates at least one measurement information error associated with the information, a third parameter that indicates at least one location information error associated with the information, and a fourth parameter that indicates at least one assistance data information error associated with the information, where the at least one parameter includes at least one of the second parameter, the third parameter, or the fourth parameter. Additionally, or alternatively, the at least one parameter includes one or more respective parameters that indicate the at least one measurement information error, the at least one location information error, and the at least one assistance data information error are associated with at least one of a target UE, an anchor UE, a server UE, or an LMF.

Additionally, or alternatively, the second SLPP message includes one or more of a first parameter that indicates at least one error associated with the first SLPP message, a second parameter that indicates at least one error associated with the information associated with a target UE, a third parameter that indicates at least one error associated with the information associated with an anchor UE, and a fourth parameter that indicates at least one error associated with the information associated with a server UE or an LMF, where the at least one parameter includes at least one of the second parameter, the third parameter, or the fourth parameter. Additionally, or alternatively, the UE 900 may be configured to support receiving, in response to the second SLPP message, a third SLPP message that indicates a third device associated with the sidelink positioning, where the first SLPP message indicates a fourth device associated with the sidelink positioning. Additionally, or alternatively, the UE 900 may be configured to support receiving, in response to the second SLPP message, a third SLPP message that indicates additional information associated with the sidelink positioning, where the additional information includes one or more of measurements associated with the sidelink position. Additionally, or alternatively, the UE 900 may be configured to support receiving, in response to the second SLPP message, a third SLPP message that indicates one or more first measurements associated with the sidelink positioning, where the information includes one or more second measurements.

Additionally, or alternatively, the first device includes at least one of a target UE, an anchor UE, a server UE, or an LMF. Additionally, or alternatively, the second device includes at least one of a target UE, an anchor UE, a server UE, or an LMF. Additionally, or alternatively, the information associated with the sidelink positioning includes one or more of measurements associated with the sidelink positioning, location information associated with the sidelink positioning, or assistance data information associated with the sidelink positioning. Additionally, or alternatively, the second SLPP message includes at least one of an SLPP error message, an SLPP provide assistance data message, or an SLPP provide location information message.

Additionally, or alternatively, the UE 900 may support at least one memory (e.g., the memory 904) and at least one processor (e.g., the processor 902) coupled with the at least one memory and configured (e.g., operable) to cause the UE to receive, from a second device, a first SLPP message including information associated with sidelink positioning, determine sidelink positioning error information based on an error in the information associated with the sidelink positioning, and transmit a second SLPP message including at least one parameter that indicates the sidelink positioning error information.

Additionally, the UE 900 may be configured to support any one or combination of the at least one parameter includes one or more values indicating that the error in the information associated with the sidelink positioning corresponds to one or more of measurement information, location information, or assistance data information. Additionally, or alternatively, the one or more values are grouped according to a type of the sidelink positioning error information, where the type of the sidelink positioning error information includes at least one of a measurement information type, a location information type, or an assistance data information type. Additionally, or alternatively, the one or more values are grouped according to the type of the second device, where the type of the second device includes at least one of a target UE, an anchor UE, a server UE, or an LMF. Additionally, or alternatively, the one or more values are grouped according to a type of the second device, where the type of the second device includes at least one of a target UE, an anchor UE, a server UE, or an LMF. Additionally, or alternatively, the second SLPP message includes one or more of a first parameter that indicates at least one error associated with the first SLPP message, a second parameter that indicates at least one measurement information error associated with the information, a third parameter that indicates at least one location information error associated with the information, and a fourth parameter that indicates at least one assistance data information error associated with the information, where the at least one parameter includes at least one of the second parameter, the third parameter, or the fourth parameter. Additionally, or alternatively, the at least one parameter includes one or more respective parameters that indicate the at least one measurement information error, the at least one location information error, and the at least one assistance data information error are associated with at least one of a target UE, an anchor UE, a server UE, or an LMF.

Additionally, or alternatively, the second SLPP message includes one or more of a first parameter that indicates at least one error associated with the first SLPP message, a second parameter that indicates at least one error associated with the information associated with a target UE, a third parameter that indicates at least one error associated with the information associated with an anchor UE, and a fourth parameter that indicates at least one error associated with the information associated with a server UE or an LMF, where the at least one parameter includes at least one of the second parameter, the third parameter, or the fourth parameter. Additionally, or alternatively, the at least one processor is configured to receive, in response to the second SLPP message, a third SLPP message that indicates a third device associated with the sidelink positioning, where the first SLPP message indicates a fourth device associated with the sidelink positioning. Additionally, or alternatively, the at least one processor is configured to receive, in response to the second SLPP message, a third SLPP message that indicates additional information associated with the sidelink positioning, where the additional information includes one or more of measurements associated with the sidelink position. Additionally, or alternatively, the at least one processor is configured to receive, in response to the second SLPP message, a third SLPP message that indicates one or more first measurements associated with the sidelink positioning, where the information includes one or more second measurements.

Additionally, or alternatively, the first device includes at least one of a target UE, an anchor UE, a server UE, or an LMF. Additionally, or alternatively, the second device includes at least one of a target UE, an anchor UE, a server UE, or an LMF. Additionally, or alternatively, the information associated with the sidelink positioning includes one or more of measurements associated with the sidelink positioning, location information associated with the sidelink positioning, or assistance data information associated with the sidelink positioning. Additionally, or alternatively, the second SLPP message includes at least one of an SLPP error message, an SLPP provide assistance data message, or an SLPP provide location information message.

The controller 906 may manage input and output signals for the UE 900. The controller 906 may also manage peripherals not integrated into the UE 900. In some implementations, the controller 906 may utilize an operating system such as iOS®, ANDROID®, WINDOWS®, or other operating systems. In some implementations, the controller 906 may be implemented as part of the processor 902.

In some implementations, the UE 900 may include at least one transceiver 908. In some other implementations, the UE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

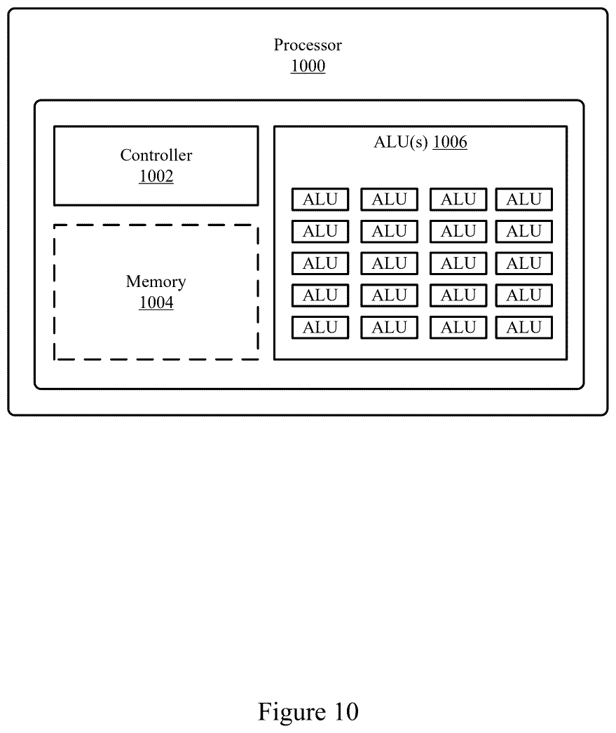

FIG. 10 illustrates an example of a processor 1000 in accordance with aspects of the present disclosure. The processor 1000 may be an example of a processor configured to perform various operations in accordance with examples as described herein. The processor 1000 may include a controller 1002 configured to perform various operations in accordance with examples as described herein. The processor 1000 may optionally include at least one memory 1004, which may be, for example, an L1/L2/L3 cache. Additionally, or alternatively, the processor 1000 may optionally include one or more arithmetic-logic units (ALUs) 1006. One or more of these components may be in electronic communication or otherwise coupled (e.g., operatively, communicatively, functionally, electronically, electrically) via one or more interfaces (e.g., buses).

The processor 1000 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1000) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1002 may be configured to manage and coordinate various operations (e.g., signaling, receiving, obtaining, retrieving, transmitting, outputting, forwarding, storing, determining, identifying, accessing, writing, reading) of the processor 1000 to cause the processor 1000 to support various operations in accordance with examples as described herein. For example, the controller 1002 may operate as a control unit of the processor 1000, generating control signals that manage the operation of various components of the processor 1000. These control signals include enabling or disabling functional units, selecting data paths, initiating memory access, and coordinating timing of operations.

The controller 1002 may be configured to fetch (e.g., obtain, retrieve, receive) instructions from the memory 1004 and determine subsequent instruction(s) to be executed to cause the processor 1000 to support various operations in accordance with examples as described herein. The controller 1002 may be configured to track memory addresses of instructions associated with the memory 1004. The controller 1002 may be configured to decode instructions to determine the operation to be performed and the operands involved. For example, the controller 1002 may be configured to interpret the instruction and determine control signals to be output to other components of the processor 1000 to cause the processor 1000 to support various operations in accordance with examples as described herein. Additionally, or alternatively, the controller 1002 may be configured to manage flow of data within the processor 1000. The controller 1002 may be configured to control transfer of data between registers, ALUs 1006, and other functional units of the processor 1000.

The memory 1004 may include one or more caches (e.g., memory local to or included in the processor 1000 or other memory, such as RAM, ROM, DRAM, SDRAM, SRAM, MRAM, flash memory, etc. In some implementations, the memory 1004 may reside within or on a processor chipset (e.g., local to the processor 1000). In some other implementations, the memory 1004 may reside external to the processor chipset (e.g., remote to the processor 1000).

The memory 1004 may store computer-readable, computer-executable code including instructions that, when executed by the processor 1000, cause the processor 1000 to perform various functions described herein. The code may be stored in a non-transitory computer-readable medium such as system memory or another type of memory. The controller 1002 and/or the processor 1000 may be configured to execute computer-readable instructions stored in the memory 1004 to cause the processor 1000 to perform various functions. For example, the processor 1000 and/or the controller 1002 may be coupled with or to the memory 1004, the processor 1000, and the controller 1002, and may be configured to perform various functions described herein. In some examples, the processor 1000 may include multiple processors and the memory 1004 may include multiple memories. One or more of the multiple processors may be coupled with one or more of the multiple memories, which may, individually or collectively, be configured to perform various functions herein.

The one or more ALUs 1006 may be configured to support various operations in accordance with examples as described herein. In some implementations, the one or more ALUs 1006 may reside within or on a processor chipset (e.g., the processor 1000). In some other implementations, the one or more ALUs 1006 may reside external to the processor chipset (e.g., the processor 1000). One or more ALUs 1006 may perform one or more computations such as addition, subtraction, multiplication, and division on data. For example, one or more ALUs 1006 may receive input operands and an operation code, which determines an operation to be executed. One or more ALUs 1006 may be configured with a variety of logical and arithmetic circuits, including adders, subtractors, shifters, and logic gates, to process and manipulate the data according to the operation. Additionally, or alternatively, the one or more ALUs 1006 may support logical operations such as AND, OR, exclusive-OR (XOR), not-OR (NOR), and not-AND (NAND), enabling the one or more ALUs 1006 to handle conditional operations, comparisons, and bitwise operations.

The processor 1000 may support wireless communications in accordance with examples as disclosed herein. The processor 1000 may be configured to or operable to support at least one controller (e.g., the controller 1002) coupled with at least one memory (e.g., the memory 1004) and configured (e.g., operable) to cause the processor to receive, from a device, a first SLPP message including information associated with sidelink positioning, determine sidelink positioning error information based on an error in the information associated with the sidelink positioning, and transmit a second SLPP message including at least one parameter that indicates the sidelink positioning error information.

Additionally, the processor 1000 may be configured to or operable to support any one or combination of the at least one parameter includes one or more values indicating that the error in the information associated with the sidelink positioning corresponds to one or more of measurement information, location information, or assistance data information. Additionally, or alternatively, the one or more values are grouped according to a type of the sidelink positioning error information, where the type of the sidelink positioning error information includes at least one of a measurement information type, a location information type, or an assistance data information type. Additionally, or alternatively, the one or more values are grouped according to the type of the device, where the type of the device includes at least one of a target UE, an anchor UE, a server UE, or an LMF. Additionally, or alternatively, the one or more values are grouped according to a type of the device, where the type of the device includes at least one of a target UE, an anchor UE, a server UE, or an LMF. Additionally, or alternatively, the second SLPP message includes one or more of a first parameter that indicates at least one error associated with the first SLPP message, a second parameter that indicates at least one measurement information error associated with the information, a third parameter that indicates at least one location information error associated with the information, and a fourth parameter that indicates at least one assistance data information error associated with the information, where the at least one parameter includes at least one of the second parameter, the third parameter, or the fourth parameter. Additionally, or alternatively, the at least one parameter includes one or more respective parameters that indicate the at least one measurement information error, the at least one location information error, and the at least one assistance data information error are associated with at least one of a target UE, an anchor UE, a server UE, or an LMF.

Additionally, or alternatively, the second SLPP message includes one or more of a first parameter that indicates at least one error associated with the first SLPP message, a second parameter that indicates at least one error associated with the information associated with a target UE, a third parameter that indicates at least one error associated with the information associated with an anchor UE, and a fourth parameter that indicates at least one error associated with the information associated with a server UE or an LMF, where the at least one parameter includes at least one of the second parameter, the third parameter, or the fourth parameter. Additionally, or alternatively, the at least one controller is configured (e.g., operable) to cause the processor to receive, in response to the second SLPP message, a third SLPP message that indicates a third device associated with the sidelink positioning, where the first SLPP message indicates a fourth device associated with the sidelink positioning. Additionally, or alternatively, the at least one controller is configured (e.g., operable) to cause the processor to receive, in response to the second SLPP message, a third SLPP message that indicates additional information associated with the sidelink positioning, where the additional information includes one or more of measurements associated with the sidelink position. Additionally, or alternatively, the at least one controller is configured (e.g., operable) to cause the processor to receive, in response to the second SLPP message, a third SLPP message that indicates one or more first measurements associated with the sidelink positioning, where the information includes one or more second measurements.

Additionally, or alternatively, the processor includes at least one of a target UE, an anchor UE, a server UE, or an LMF. Additionally, or alternatively, the device includes at least one of a target UE, an anchor UE, a server UE, or an LMF. Additionally, or alternatively, the information associated with the sidelink positioning includes one or more of measurements associated with the sidelink positioning, location information associated with the sidelink positioning, or assistance data information associated with the sidelink positioning. Additionally, or alternatively, the second SLPP message includes at least one of an SLPP error message, an SLPP provide assistance data message, or an SLPP provide location information message.

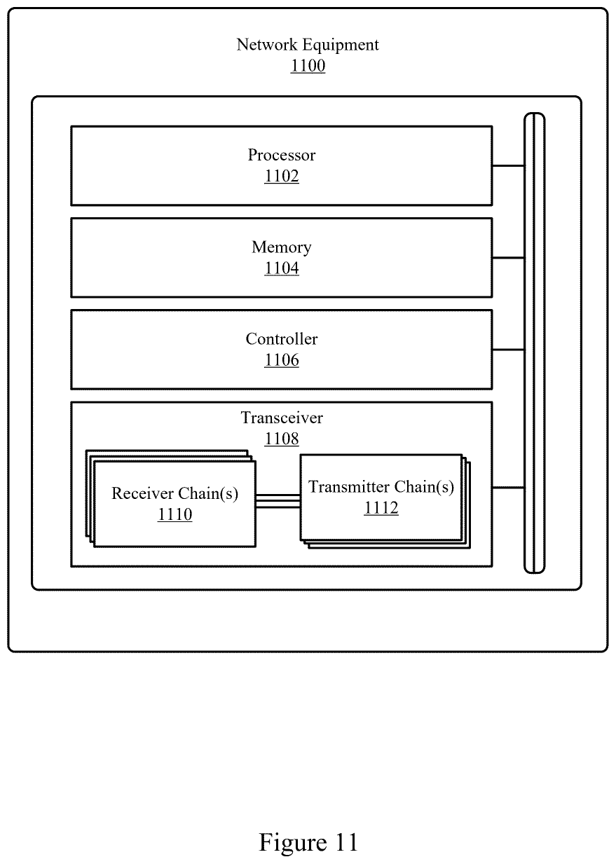

FIG. 11 illustrates an example of an NE 1100 in accordance with aspects of the present disclosure. The NE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the NE 1100 to perform various functions of the present disclosure.

The memory 1104 may include volatile or non-volatile memory. The memory 1104 may store computer-readable, computer-executable code including instructions when executed by the processor 1102 cause the NE 1100 to perform various functions described herein. The code may be stored in a non-transitory computer-readable medium such as the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured (e.g., operable) to cause the NE 1100 to perform one or more of the functions described herein (e.g., executing, by the processor 1102, instructions stored in the memory 1104). For example, the processor 1102 may support wireless communications at the NE 1100 in accordance with examples as disclosed herein. The NE 1100 may be configured to or operable to support a means for receiving, from a second device, a first SLPP message including at least one parameter that indicates sidelink positioning error information associated with a second SLPP message, where the sidelink positioning error information is based on an error in information associated with sidelink positioning, and transmitting, to the second device, a third SLPP message based on the sidelink positioning error information.

Additionally, the NE 1100 may be configured to or operable to support any one or combination of the at least one parameter includes one or more values indicating that the error in the information associated with the sidelink positioning corresponds to one or more of measurement information, location information, or assistance data information. Additionally, or alternatively, the one or more values are grouped according to a type of the sidelink positioning error information, where the type of the sidelink positioning error information includes at least one of a measurement information type, a location information type, or an assistance data information type. Additionally, or alternatively, the one or more values are grouped according to the type of the second device, where the type of the second device includes at least one of a target UE, an anchor UE, or a server UE. Additionally, or alternatively, the one or more values are grouped according to a type of the second device, where the type of the second device includes at least one of a target UE, an anchor UE, a server UE, or an LMF. Additionally, or alternatively, the first SLPP message includes one or more of a first parameter that indicates at least one error associated with the second SLPP message, a second parameter that indicates at least one measurement information error associated with the information, a third parameter that indicates at least one location information error associated with the information, and a fourth parameter that indicates at least one assistance data information error associated with the information, where the at least one parameter includes at least one of the second parameter, the third parameter, or the fourth parameter. Additionally, or alternatively, the at least one parameter includes one or more respective parameters that indicate the at least one measurement information error, the at least one location information error, and the at least one assistance data information error are associated with at least one of a target UE, an anchor UE, a server UE, or an LMF.

Additionally, or alternatively, the first SLPP message includes one or more of a first parameter that indicates at least one error associated with the second SLPP message, a second parameter that indicates at least one error associated with the information associated with a target UE, a third parameter that indicates at least one error associated with the information associated with an anchor UE, and a fourth parameter that indicates at least one error associated with the information associated with a server UE or an LMF, where the at least one parameter includes at least one of the second parameter, the third parameter, or the fourth parameter. Additionally, or alternatively, the third SLPP message indicates a third device associated with the sidelink positioning, where the second SLPP message indicates a fourth device associated with the sidelink positioning. Additionally, or alternatively, the third SLPP message indicates additional information associated with the sidelink positioning, where the additional information includes one or more of measurements associated with the sidelink position. Additionally, or alternatively, the NE 1100 may be configured to or operable to support transmitting, prior to receiving the first SLPP message, the second SLPP message, where the second SLPP message includes one or more first measurements associated with the sidelink positioning, and obtaining, based on receiving the first SLPP message, one or more second measurements associated with the sidelink positioning, where the third SLPP message includes the one or more second measurements.

Additionally, or alternatively, the first device includes at least one of a target UE, an anchor UE, a server UE, or an LMF. Additionally, or alternatively, the second device includes at least one of a target UE, an anchor UE, a server UE, or an LMF. Additionally, or alternatively, the information associated with the sidelink positioning includes one or more of measurements associated with the sidelink positioning, location information associated with the sidelink positioning, or assistance data information associated with the sidelink positioning. Additionally, or alternatively, the first SLPP message includes at least one of an SLPP error message, an SLPP provide assistance data message, or an SLPP provide location information message.

Additionally, or alternatively, the NE 1100 may support at least one memory (e.g., the memory 1104) and at least one processor (e.g., the processor 1102) coupled with the at least one memory and configured (e.g., operable) to cause the NE to receive, from a second device, a first SLPP message including at least one parameter that indicates sidelink positioning error information associated with a second SLPP message, where the sidelink positioning error information is based on an error in information associated with sidelink positioning, and transmit, to the second device, a third SLPP message based on the sidelink positioning error information.

Additionally, the NE 1100 may be configured to support any one or combination of the at least one parameter includes one or more values indicating that the error in the information associated with the sidelink positioning corresponds to one or more of measurement information, location information, or assistance data information. Additionally, or alternatively, the one or more values are grouped according to a type of the sidelink positioning error information, where the type of the sidelink positioning error information includes at least one of a measurement information type, a location information type, or an assistance data information type. Additionally, or alternatively, the one or more values are grouped according to the type of the second device, where the type of the second device includes at least one of a target UE, an anchor UE, or a server UE. Additionally, or alternatively, the one or more values are grouped according to a type of the second device, where the type of the second device includes at least one of a target UE, an anchor UE, a server UE, or an LMF. Additionally, or alternatively, the first SLPP message includes one or more of a first parameter that indicates at least one error associated with the second SLPP message, a second parameter that indicates at least one measurement information error associated with the information, a third parameter that indicates at least one location information error associated with the information, and a fourth parameter that indicates at least one assistance data information error associated with the information, where the at least one parameter includes at least one of the second parameter, the third parameter, or the fourth parameter. Additionally, or alternatively, the at least one parameter includes one or more respective parameters that indicate the at least one measurement information error, the at least one location information error, and the at least one assistance data information error are associated with at least one of a target UE, an anchor UE, a server UE, or an LMF.

Additionally, or alternatively, the first SLPP message includes one or more of a first parameter that indicates at least one error associated with the second SLPP message, a second parameter that indicates at least one error associated with the information associated with a target UE, a third parameter that indicates at least one error associated with the information associated with an anchor UE, and a fourth parameter that indicates at least one error associated with the information associated with a server UE or an LMF, where the at least one parameter includes at least one of the second parameter, the third parameter, or the fourth parameter. Additionally, or alternatively, the third SLPP message indicates a third device associated with the sidelink positioning, where the second SLPP message indicates a fourth device associated with the sidelink positioning. Additionally, or alternatively, the third SLPP message indicates additional information associated with the sidelink positioning, where the additional information includes one or more of measurements associated with the sidelink position. Additionally, or alternatively, the at least one processor is configured (e.g., operable) to cause the NE to transmit, prior to receiving the first SLPP message, the second SLPP message, where the second SLPP message includes one or more first measurements associated with the sidelink positioning, and obtain, based on receiving the first SLPP message, one or more second measurements associated with the sidelink positioning, where the third SLPP message includes the one or more second measurements.

Additionally, or alternatively, the first device includes at least one of a target UE, an anchor UE, a server UE, or an LMF. Additionally, or alternatively, the second device includes at least one of a target UE, an anchor UE, a server UE, or an LMF. Additionally, or alternatively, the information associated with the sidelink positioning includes one or more of measurements associated with the sidelink positioning, location information associated with the sidelink positioning, or assistance data information associated with the sidelink positioning. Additionally, or alternatively, the first SLPP message includes at least one of an SLPP error message, an SLPP provide assistance data message, or an SLPP provide location information message.

The controller 1106 may manage input and output signals for the NE 1100. The controller 1106 may also manage peripherals not integrated into the NE 1100. In some implementations, the controller 1106 may utilize an operating system such as iOS®, ANDROID®, WINDOWS®, or other operating systems. In some implementations, the controller 1106 may be implemented as part of the processor 1102.

In some implementations, the NE 1100 may include at least one transceiver 1108. In some other implementations, the NE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas to receive a signal over the air or wireless medium. The receiver chain 1110 may include at least one amplifier (e.g., a low-noise amplifier (LNA)) configured to amplify the received signal. The receiver chain 1110 may include at least one demodulator configured to demodulate the receive signal and obtain the transmitted data by reversing the modulation technique applied during transmission of the signal. The receiver chain 1110 may include at least one decoder for decoding the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

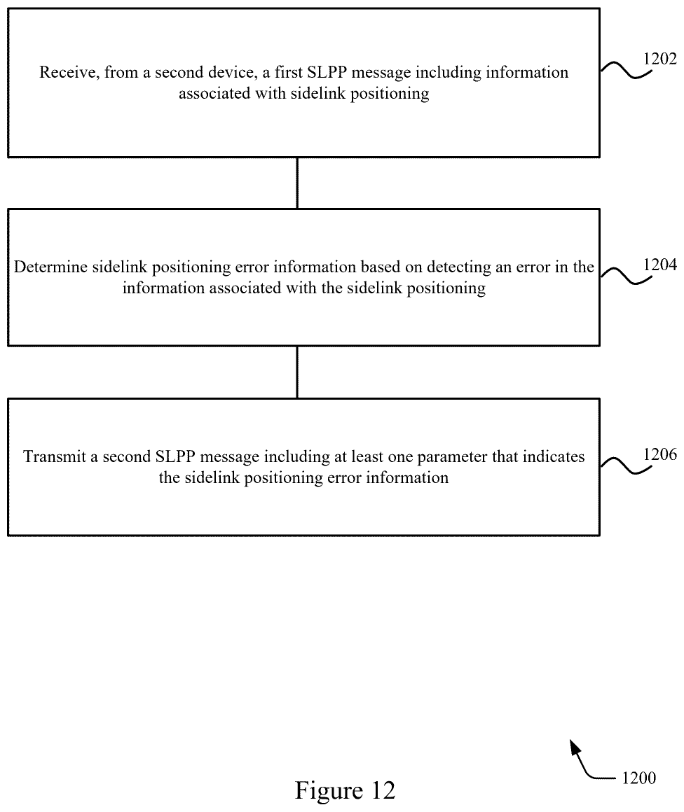

FIG. 12 illustrates a flowchart of a method 1200 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1202, the method may include receiving, from a second device, a first SLPP message including information associated with sidelink positioning. The operations of 1202 may be performed in accordance with examples as described herein. In some implementations, aspects of the operations of 1202 may be performed by a UE as described with reference to FIG. 9 or by an NE as described with reference to FIG. 11.

At 1204, the method may include determining sidelink positioning error information based on an error in the information associated with the sidelink positioning. The operations of 1204 may be performed in accordance with examples as described herein. In some implementations, aspects of the operations of 1204 may be performed by a UE as described with reference to FIG. 9 or by an NE as described with reference to FIG. 11.

At 1206, the method may include transmitting a second SLPP message including at least one parameter that indicates the sidelink positioning error information. The operations of 1206 may be performed in accordance with examples as described herein. In some implementations, aspects of the operations of 1206 may be performed a UE as described with reference to FIG. 9 or by an NE as described with reference to FIG. 11.

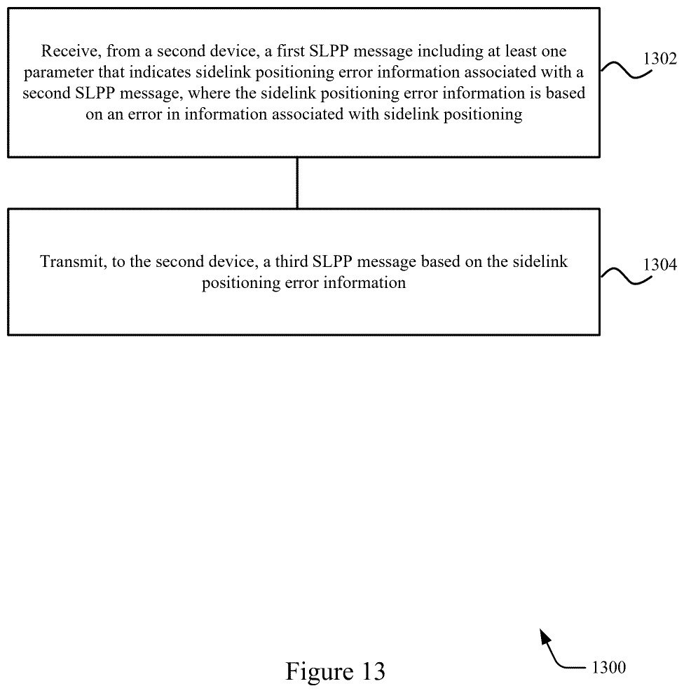

FIG. 13 illustrates a flowchart of a method 1300 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1302, the method may include receiving, from a second device, a first SLPP message including at least one parameter that indicates sidelink positioning error information associated with a second SLPP message, where the sidelink positioning error information is based on an error in information associated with sidelink positioning. The operations of 1302 may be performed in accordance with examples as described herein. In some implementations, aspects of the operations of 1302 may be performed by a UE as described with reference to FIG. 9 or by an NE as described with reference to FIG. 11.

At 1304, the method may include transmitting, to the second device, a third SLPP message based on the sidelink positioning error information. The operations of 1304 may be performed in accordance with examples as described herein. In some implementations, aspects of the operations of 1304 may be performed by a UE as described with reference to FIG. 9 or by an NE as described with reference to FIG. 11.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first device for wireless communication, comprising:
at least one memory; and
at least one processor coupled with the at least one memory and operable to cause the first device to:
receive, from a second device, a first sidelink positioning protocol (SLPP) message comprising information associated with sidelink positioning;
determine sidelink positioning error information based at least in part on an error in the information associated with the sidelink positioning; and
transmit a second SLPP message comprising at least one parameter that indicates the sidelink positioning error information.

2. The first device of claim 1, wherein the at least one parameter comprises one or more values indicating that the error in the information associated with the sidelink positioning corresponds to one or more of measurement information, location information, or assistance data information.

3. The first device of claim 2, wherein the one or more values are grouped according to a type of the sidelink positioning error information, and wherein the type of the sidelink positioning error information comprises at least one of a measurement information type, a location information type, or an assistance data information type, and wherein the one or more values are grouped according to the type of the second device, and wherein the type of the second device comprises at least one of a target user equipment (UE), an anchor UE, a server UE, or a location management function (LMF).

4. The first device of claim 2, wherein the one or more values are grouped according to a type of the second device, and wherein the type of the second device comprises at least one of a target user equipment (UE), an anchor UE, a server UE, or a location management function (LMF).

5. The first device of claim 1, wherein the second SLPP message comprises one or more of a first parameter that indicates at least one error associated with the first SLPP message, a second parameter that indicates at least one measurement information error associated with the information, a third parameter that indicates at least one location information error associated with the information, and a fourth parameter that indicates at least one assistance data information error associated with the information, and wherein the at least one parameter comprises at least one of the second parameter, the third parameter, or the fourth parameter, and wherein the at least one parameter comprises one or more respective parameters that indicate the at least one measurement information error, the at least one location information error, and the at least one assistance data information error are associated with at least one of a target user equipment (UE), an anchor UE, a server UE, or a location management function (LMF).

6. The first device of claim 1, wherein the second SLPP message comprises one or more of a first parameter that indicates at least one error associated with the first SLPP message, a second parameter that indicates at least one error associated with the information associated with a target user equipment (UE), a third parameter that indicates at least one error associated with the information associated with an anchor UE, and a fourth parameter that indicates at least one error associated with the information associated with a server UE or a location management function (LMF), and wherein the at least one parameter comprises at least one of the second parameter, the third parameter, or the fourth parameter.

7. The first device of claim 1, wherein the at least one processor is operable to cause the first device to receive, in response to the second SLPP message, a third SLPP message that indicates a third device associated with the sidelink positioning, and wherein the first SLPP message indicates a fourth device associated with the sidelink positioning.

8. The first device of claim 1, wherein the at least one processor is operable to cause the first device to receive, in response to the second SLPP message, a third SLPP message that indicates additional information associated with the sidelink positioning, and wherein the additional information comprises one or more of measurements associated with the sidelink position, and wherein the additional information comprises one or more of measurements associated with the sidelink positioning, location information associated with the sidelink positioning, or assistance data information associated with the sidelink positioning.

9. The first device of claim 1, wherein the at least one processor is operable to cause the first device to receive, in response to the second SLPP message, a third SLPP message that indicates one or more first measurements associated with the sidelink positioning, and wherein the information comprises one or more second measurements.

10. The first device of claim 1, wherein the information associated with the sidelink positioning comprises one or more of measurements associated with the sidelink positioning, location information associated with the sidelink positioning, or assistance data information associated with the sidelink positioning.

11. The first device of claim 1, wherein the second SLPP message comprises at least one of an SLPP error message, an SLPP provide assistance data message, or an SLPP provide location information message.

12. A method performed by a first device, the method comprising:
receiving, from a second device, a first sidelink positioning protocol (SLPP) message comprising information associated with sidelink positioning;
determining sidelink positioning error information based at least in part on an error in the information associated with the sidelink positioning; and
transmitting a second SLPP message comprising at least one parameter that indicates the sidelink positioning error information.

13. A first device for wireless communication, comprising:
at least one memory; and
at least one processor coupled with the at least one memory and operable to cause the first device to:
receive, from a second device, a first sidelink positioning protocol (SLPP) message comprising at least one parameter that indicates sidelink positioning error information associated with a second SLPP message, wherein the sidelink positioning error information is based at least in part on an error in information associated with sidelink positioning; and
transmit, to the second device, a third SLPP message based at least in part on the sidelink positioning error information.

14. The first device of claim 13, wherein the at least one parameter comprises one or more values indicating that the error in the information associated with the sidelink positioning corresponds to one or more of measurement information, location information, or assistance data information.

15. The first device of claim 14, wherein the one or more values are grouped according to a type of the sidelink positioning error information, and wherein the type of the sidelink positioning error information comprises at least one of a measurement information type, a location information type, or an assistance data information type, and wherein the one or more values are grouped according to the type of the second device, and wherein the type of the second device comprises at least one of a target user equipment (UE), an anchor UE, or a server UE.

16. The first device of claim 14, wherein the one or more values are grouped according to a type of the second device, and wherein the type of the second device comprises at least one of a target user equipment (UE), an anchor UE, a server UE, or a location management function (LMF).

17. The first device of claim 13, wherein the first SLPP message comprises one or more of a first parameter that indicates at least one error associated with the second SLPP message, a second parameter that indicates at least one measurement information error associated with the information, a third parameter that indicates at least one location information error associated with the information, and a fourth parameter that indicates at least one assistance data information error associated with the information, and wherein the at least one parameter comprises at least one of the second parameter, the third parameter, or the fourth parameter, and wherein the at least one parameter comprises one or more respective parameters that indicate the at least one measurement information error, the at least one location information error, and the at least one assistance data information error are associated with at least one of a target user equipment (UE), an anchor UE, a server UE, or a location management function (LMF).

18. The first device of claim 13, wherein the first SLPP message comprises one or more of a first parameter that indicates at least one error associated with the second SLPP message, a second parameter that indicates at least one error associated with the information associated with a target user equipment (UE), a third parameter that indicates at least one error associated with the information associated with an anchor UE, and a fourth parameter that indicates at least one error associated with the information associated with a server UE or a location management function (LMF), and wherein the at least one parameter comprises at least one of the second parameter, the third parameter, or the fourth parameter.

19. The first device of claim 13, wherein the at least one processor is operable to cause the first device to:
transmit, prior to receiving the first SLPP message, the second SLPP message, wherein the second SLPP message comprises one or more first measurements associated with the sidelink positioning; and
obtain, based at least in part on receiving the first SLPP message, one or more second measurements associated with the sidelink positioning, wherein the third SLPP message comprises the one or more second measurements.

20. A method performed by a first device, the method comprising:
receiving, from a second device, a first sidelink positioning protocol (SLPP) message comprising at least one parameter that indicates sidelink positioning error information associated with a second SLPP message, wherein the sidelink positioning error information is based at least in part on an error in information associated with sidelink positioning; and
transmitting, to the second device, a third SLPP message based at least in part on the sidelink positioning error information.
